(19) United States
(12) Patent Application Publication
(10) Pub. No.: US 2012/0256726 A1
(43) Pub. Date: Oct. 11, 2012

(54) METHOD, APPARATUS, AND COMPUTER PROGRAM PRODUCT FOR SPECIAL DEDICATED INQUIRY AND INQUIRY RESPONSE PROCESS FOR DEDICATED DEVICE SEARCH

(75) Inventors: Mauri Juhana HONKANEN, Tampere (FI); Jukka Pekka Reunamäki, Tampere (FI); Arto Tapio Palin, Viiala (FI)

(73) Assignee: Nokia Corporation, Espoo (FI)

(21) Appl. No.: 13/081,583

(22) Filed: Apr. 7, 2011

(51) Int. Cl. H04Q 5/22

(52) U.S. Cl. 340/10.1

(57) ABSTRACT

Method, apparatus, and computer program product example embodiments provide direction finding information exchange without establishment of a formal communication connection. In an example embodiment, a special value is reserved for an inquiry access code, to signify that an inquiring device that transmits the special code is a direction finding capable device that is capable of receiving and using information usable for estimating at least a relative direction, for direction estimation. In an example embodiment, an inquiry scanning device that recognizes the special code, is capable of generating and transmitting information usable for estimating at least a relative direction, for direction estimation.

### FIELD

The technology field relates to wireless short-range communication and more particularly to direction finding information exchange without establishment of a formal communication connection.

### BACKGROUND

Modern society has adopted, and is becoming reliant upon, wireless communication devices for various purposes, such as, connecting users of the wireless communication devices with other users. Wireless communication devices can vary from battery powered handheld devices to stationary household and / or commercial devices utilizing electrical network as a power source. Due to rapid development of the wireless communication devices a number of areas capable of enabling entirely new types of communication applications have emerged.

An example of a wireless short-range communication technology is Bluetooth™ communication protocol, which operates in the 2.4 GHz ISM band. Bluetooth™ is a short-range radio network, originally intended as a cable replacement. Bluetooth™ Technical Specifications are published by the Bluetooth™ SIG, Inc. Bluetooth™ Specification version 2.0+EDR, published Oct. 15, 2004 has the original functional characteristics of the first version Bluetooth™ Basic Rate (BR) and adds the Enhanced Data Rate (EDR) feature. Bluetooth™ Specification version 2.1+EDR, published Jul. 26, 2007 for Basic Rate/Enhanced Data Rate (BR/EDR), added definitions for new features: Encryption Pause Resume, Erroneous Data reporting, Extended Inquiry Response, Link Supervision Timeout Event, Packet Boundary Flag, Secure Simple Pairing, Sniff Subrating. Bluetooth™ Specification version 3.0+HS, published Apr. 21, 2009, updated the standard to integrate the Alternate MAC/PHY and Unicast Connectionless Data features.

On Jun. 30, 2010, the Bluetooth™ SIG published the Bluetooth™ Core Specification, Version 4.0 (incorporated herein by reference), which includes the Extended Inquiry Response. An Extended Inquiry Response may be used to provide miscellaneous information during the inquiry response procedure. Data types may be defined for such things as local name and supported services, information that otherwise would have to be obtained by establishing a connection. A device that receives a local name and a list of supported services in an extended inquiry response does not have to connect to do a remote name request and a service discovery protocol (SDP) service search, thereby shortening the time to useful information.

### SUMMARY

Method, apparatus, and computer program product example embodiments provide direction finding information exchange without establishment of a formal communication connection.

In an example embodiment of the invention, a special value is reserved for an inquiry access code, to signify that an inquiring device that transmits the special code is a direction finding capable device that is capable of receiving and using information usable for estimating at least a relative direction, for direction estimation. In an example embodiment of the invention, an inquiry scanning device that recognizes the special code, is capable of generating and transmitting such information. If an inquiry scanning device is capable of recognizing the new, specially reserved value for the special code when it receives an inquiry message from an inquiring device, the scanning device will respond by generating and transmitting the information usable for estimating at least a relative direction, in accordance with example embodiments of the invention. If the inquiry scanning device has one or more antennas for transmitting the information usable for estimating at least a relative direction and the inquiring device has an antenna array for receiving the information usable for estimating at least a relative direction, then the receiving, inquiring device will estimate the angle of arrival (AoA) with respect to itself, in accordance with example embodiments of the invention. Alternately, if the inquiry scanning device has an antenna array to transmit the information usable for estimating at least a relative direction and the inquiring device has one or more antennas to receive the information usable for estimating at least a relative direction, then the receiving, inquiring device will estimate the angle of departure (AoD) with respect to the transmitter, in accordance with example embodiments of the invention. In embodiments of the invention, two special values may be reserved for the inquiry access code, one for estimating the angle of arrival (AoA) and another for estimating the angle of departure (AoD).

According to an example embodiment of the invention, a method comprises

scanning, by an apparatus, for wireless signals, the wireless signals comprising one or more inquiry messages;

receiving one or more predetermined dedicated inquiry messages and in response, providing information usable for estimating at least a relative direction of the apparatus; and

transmitting one or more response messages including an information message containing the information usable for estimating at least a relative direction of the apparatus.

In an example embodiment of the invention, the one or more predetermined dedicated inquiry messages includes a special value reserved for a Bluetooth™ inquiry access code, which signifies that a device sending the one or more predetermined dedicated inquiry messages is capable of receiving and using information usable for estimating at least a relative direction of the apparatus, for direction estimation.

In an example embodiment of the invention, the one or more predetermined dedicated inquiry messages includes a special value reserved for a Bluetooth™ inquiry access code, which initiates the response by the apparatus.

In an example embodiment of the invention, the one or more response messages includes a Bluetooth™ extended inquiry response packet that includes a data type indication to inform a receiving device that direction estimation data associated with the information usable for estimating at least a relative direction of the apparatus exists in one of a tail portion of the Bluetooth™ extended inquiry response packet or a payload portion of the Bluetooth™ extended inquiry response packet.

In an example embodiment of the invention, the one or more response messages includes a Bluetooth™ FHS packet with an indication to inform a receiving device that direction estimation data associated with the information usable for estimating at least a relative direction of the apparatus exists in a subsequent packet after the FHS packet.

In an example embodiment of the invention, the one or more response messages includes a Bluetooth™ extended inquiry response packet that includes FHS data and a data type indication to inform a receiving device that direction estimation data associated with the information usable for estimating at least a relative direction of the apparatus exists in one of a tail portion of the Bluetooth™ extended inquiry response packet or a payload portion of the Bluetooth™ extended inquiry response packet.

In an example embodiment of the invention, direction estimation data associated with the information usable for estimating at least a relative direction of the apparatus enables at least one of an angle of departure estimation and an angle of arrival estimation.

In an example embodiment of the invention, the method further comprises modifying device detection procedure associated with the one or more predetermined dedicated inquiry messages, in response to receiving the one or more predetermined dedicated inquiry messages, by at least one of increasing a duration of an inquiry scanning window and decreasing a duration of an inquiry scanning interval.

In an example embodiment of the invention, if the one or more predetermined dedicated inquiry messages include a first special value, then direction estimation data associated with the information usable for estimating at least a relative direction enables an angle of departure estimation and if the one or more predetermined dedicated inquiry messages include a second special value different from the first special value, then direction estimation data associated with the information usable for estimating at least a relative direction enables an angle of arrival estimation.

According to an example embodiment of the invention, a method comprises

transmitting, by an apparatus, one or more wireless predetermined dedicated inquiry messages;

receiving, by the apparatus from a remote device, one or more wireless response messages including an information message containing information usable for estimating at least a relative direction of the remote device, the one or more response messages being received in response to the one or more predetermined dedicated inquiry messages;

determining that the one or more wireless response messages include information usable for estimating at least a relative direction of the remote device; and

generating positioning data in the apparatus based on the received information usable for estimating at least a relative direction of the remote device, for direction estimation.

In an example embodiment of the invention, the one or more wireless predetermined dedicated inquiry messages includes a special value reserved for a Bluetooth™ inquiry access code, which signifies that the apparatus is capable of receiving and using information usable for estimating at least a relative direction of the remote device, for direction estimation.

In an example embodiment of the invention, the one or more wireless response messages includes a Bluetooth™ extended inquiry response packet that includes a data type indication to inform a receiving device that direction estimation data associated with the information usable for estimating at least a relative direction of the remote device exists in one of a tail portion of the Bluetooth™ extended inquiry response packet or a payload portion of the Bluetooth™ extended inquiry response packet.

In an example embodiment of the invention, the one or more wireless response messages includes a Bluetooth™ FHS packet with an indication to inform a receiving device that direction estimation data associated with the information usable for estimating at least a relative direction of the remote device exists in a subsequent packet after the FHS packet.

In an example embodiment of the invention, the one or more wireless response messages includes a Bluetooth™ extended inquiry response packet that includes FHS data and a data type indication to inform a receiving device that direction estimation data associated with the information usable for estimating at least a relative direction of the remote device exists in one of a tail portion of the Bluetooth™ extended inquiry response packet or a payload portion of the Bluetooth™ extended inquiry response packet.

In an example embodiment of the invention, direction estimation data associated with the information usable for estimating at least a relative direction enables at least one of an angle of departure estimation and an angle of arrival estimation.

In an example embodiment of the invention, the method further comprising processing direction data associated with the information usable for estimating at least a relative direction of the remote device to enable the generating of the positioning data, for direction estimation.

Example embodiments of the invention include a computer program product comprising computer executable program code recorded on a computer readable non-transitory storage medium, to perform the above methods.

Example embodiments of the invention include an apparatus, comprising:

at least one processor;

at least one memory including computer program code;

the at least one memory and the computer program code configured to, with the at least one processor, cause the apparatus at least to:

scan for wireless signals, the wireless signals comprising one or more inquiry messages;

receive one or more predetermined dedicated inquiry messages and in response, provide information usable for estimating at least a relative direction of the apparatus; and

transmit one or more response messages including an information message containing the information usable for estimating at least a relative direction of the apparatus.

Example embodiments of the invention include an apparatus, comprising:

at least one processor;

at least one memory including computer program code;

the at least one memory and the computer program code configured to, with the at least one processor, cause the apparatus at least to:

transmit one or more wireless predetermined dedicated inquiry messages;

receive from a remote device, one or more wireless response messages including an information message containing information usable for estimating at least a relative direction of the remote device, the one or more response messages being received in response to the one or more predetermined dedicated inquiry messages;

determine that the one or more wireless response messages include information usable for estimating at least a relative direction of the remote device; and

generate positioning data in the apparatus based on the received information usable for estimating at least a relative direction of the remote device, for direction estimation.

The example embodiments of the invention provide Bluetooth™ direction finding information exchange in a backwards compatible format, without establishment of a formal communication connection.

### DESCRIPTION OF THE FIGURES:

FIG. 1, for an example of angle of departure (AoD) estimation, discloses a location enhanced Bluetooth™ device in inquiry scanning mode, receiving a predetermined dedicated inquiry (DIAC) packet from another Bluetooth™ device, and in response, modifying its device detection procedure to improve detection of inquiry signals, by either enlarging the inquiry scan window or reducing the interval between scans, in accordance with at least one embodiment of the present invention.

FIG. 1A, for an example of angle of departure (AoD) estimation, discloses an example network diagram illustrating a first location enhanced Bluetooth™ device in inquiry scanning mode receiving a predetermined dedicated inquiry (DIAC) packet from a second location enhanced Bluetooth™ device that is a direction finding capable device in inquiry mode, in accordance with at least one embodiment of the present invention.

FIG. 1B, for an example of angle of departure (AoD) estimation, discloses the example network diagram of FIG. 1A, of the inquiry scanning device responding to receiving the predetermined dedicated inquiry (DIAC) packet by providing information usable for estimating at least a relative direction. In embodiments of the invention, the inquiry scanning device transmits the extended inquiry response packet in a backwards compatible format, with the information usable for estimating at least a relative direction, in a first transmission interval in a normal Bluetooth™ transmission, in accordance with at least one embodiment of the present invention.

FIG. 1C, for an example of angle of departure (AoD) estimation, discloses the example network diagram of FIGS. 1A and 1B, of the inquiring device receiving during a first receiving interval, the extended inquiry response packet including the information usable for estimating at least a relative direction and determining that the extended inquiry response packet includes information usable for estimating at least a relative direction, in accordance with at least one embodiment of the present invention.

FIG. 1D, for an example of angle of departure (AoD) estimation, discloses an example timing diagram for an example exchange between the devices, of a predetermined dedicated inquiry (DIAC) packet transmitted from the inquiring device, and an inquiry response FHS packet and an extended inquiry response packet transmitted from the inquiry scanning device in a first transmission interval in a normal Bluetooth™ transmission, the extended inquiry response packet including the information usable for estimating at least a relative direction, and further shows an example timing of the reference data stream in a second transmission interval from the inquiry scanning device where antenna elements of the antenna array are sequentially switched during transmitting the reference pattern.

FIG. 1E, for an example of angle of departure (AoD) estimation, discloses an example of how the bits in the reference data stream, from the extended inquiry response packet, are transmitted by the antenna array at the inquiry scanning device and sampled at the inquiring device, in accordance with at least one embodiment of the present invention.

FIG. 1F, for an example of angle of departure (AoD) estimation, discloses the example network diagram of FIG. 1A, in an alternate embodiment wherein the inquiry scanning device responds to receiving the predetermined dedicated inquiry (DIAC) packet by a simplified procedure of including part or all of the FHS data in the extended inquiry response packet, along with the information usable for estimating at least a relative direction that it transmits, thereby rendering unnecessary the transmission of a separate FHS packet, in accordance with at least one embodiment of the present invention.

FIG. 1G, for an example of angle of departure (AoD) estimation, discloses an example timing diagram for the alternate embodiment of FIG. 1F, of a predetermined dedicated inquiry (DIAC) packet transmitted from the inquiring device and a simplified procedure of an extended inquiry response packet transmitted from the inquiry scanning device that includes FHS data, thereby rendering unnecessary the transmission of a separate FHS packet, in accordance with at least one embodiment of the present invention.

FIG. 2A, for an example of angle of departure (AoD) estimation, discloses an example network diagram illustrating a relative location along a first axis of the inquiry scanning device and the inquiring device. In embodiments of the invention, in a second transmission interval, the inquiry scanning device transmits the reference data stream based on the information usable for estimating at least a relative direction. The inquiring device receives the reference data stream in a second receiving interval and decodes the reference data stream to obtain a direction value, based on the extended inquiry response packet with the information usable for estimating at least a relative direction, in accordance with at least one embodiment of the present invention.

FIG. 2B, for an example of angle of departure (AoD) estimation, discloses an example network diagram illustrating a second relative location along a second axis offset from the first axis, of the inquiry scanning device and the inquiring device. In embodiments of the invention, in a second transmission interval, the inquiry scanning device transmits reference data stream based on the information usable for estimating at least a relative direction. The inquiring device receives the reference data stream in a second receiving interval and decodes the reference data stream to obtain a direction value, based on the extended inquiry response packet with the information usable for estimating at least a relative direction, in accordance with at least one embodiment of the present invention.

FIG. 3A, for an example of angle of departure (AoD) estimation, is an example embodiment of a flow diagram of an example method, from the point of view of the inquiry scanning device receiving a predetermined dedicated inquiry (DIAC) packet, in accordance with at least one embodiment of the present invention.

FIG. 3B, for an example of angle of departure (AoD) estimation, is an example embodiment of a flow diagram of an example method, from the point of view of the inquiring device transmitting a predetermined dedicated inquiry (DIAC) packet, in accordance with at least one embodiment of the present invention.

FIG. 3C, for an example of angle of departure (AoD) estimation, is an example embodiment of a flow diagram of an example alternate method, from the point of view of the inquiring device transmitting a predetermined dedicated inquiry (DIAC) packet, in accordance with at least one embodiment of the present invention.

FIG. 4, for an example of angle of arrival (AoA) estimation, discloses a location enhanced Bluetooth™ device in inquiry scanning mode, receiving a predetermined dedicated inquiry (DIAC) packet from another Bluetooth™ device, and in response, modifying its device detection procedure to improve detection of inquiry signals, by either enlarging the inquiry scan window or reducing the interval between scans, in accordance with at least one embodiment of the present invention.

FIG. 4A, for an example of angle of arrival (AoA) estimation, discloses an example network diagram illustrating a location enhanced Bluetooth™ device in inquiry scanning mode receiving a predetermined dedicated inquiry (DIAC) packet from a location enhanced Bluetooth™ device that is a direction finding capable device in inquiry mode, in accordance with at least one embodiment of the present invention.

FIG. 4B, for an example of angle of arrival (AoA) estimation, discloses the example network diagram of FIG. 4A, of the inquiry scanning device responding to a predetermined dedicated inquiry (DIAC) packet by providing information usable for estimating at least a relative direction. In embodiments of the invention, in a first transmission interval, the inquiry scanning device transmits the extended inquiry response packet with the information usable for estimating at least a relative direction, in a normal Bluetooth™ transmission, in accordance with at least one embodiment of the present invention.

FIG. 4C, for an example of angle of arrival (AoA) estimation, discloses the example network diagram of FIGS. 4A and 4B, of the inquiring device receiving during a first receiving interval, the extended inquiry response packet including the information usable for estimating at least a relative direction and determining that the extended inquiry response packet includes information usable for estimating at least a relative direction, in accordance with at least one embodiment of the present invention.

FIG. 4D, for an example of angle of arrival (AoA) estimation, discloses an example timing diagram for an example exchange between the devices, of a predetermined dedicated inquiry (DIAC) packet transmitted from the inquiring device, and an inquiry response FHS packet and an extended inquiry response packet transmitted from the inquiry scanning device in a normal Bluetooth™ transmission, the extended inquiry response packet including the information usable for estimating at least a relative direction, the figure further showing an example timing of the reference data stream transmission from the inquiry scanning device, which is received by the antenna array at the inquiring device, the antenna array sequentially switching the reference data stream during reception.

FIG. 4E, for an example of angle of arrival (AoA) estimation, discloses an example of how the bits in the reference pattern from the extended inquiry response packet are transmitted by the single antenna at the inquiry scanning device and received by the antenna array and sampled at the inquiring device, in accordance with at least one embodiment of the present invention.

FIG. 4F, for an example of angle of arrival (AoA) estimation, discloses the example network diagram of FIG. 1A, in an alternate embodiment wherein the inquiry scanning device responds to receiving the predetermined dedicated inquiry (DIAC) packet by a simplified procedure of including part or all of the FHS data in the extended inquiry response packet, along with the information usable for estimating at least a relative direction that it transmits, thereby rendering unnecessary the transmission of a separate FHS packet, in accordance with at least one embodiment of the present invention.

FIG. 4G, for an example of angle of arrival (AoA) estimation, discloses an example timing diagram for the alternate embodiment of FIG. 4F, of a predetermined dedicated inquiry (DIAC) packet transmitted from the inquiring device and a simplified procedure of an extended inquiry response packet transmitted from the inquiry scanning device that includes FHS data, thereby rendering unnecessary the transmission of a separate FHS packet, in accordance with at least one embodiment of the present invention.

FIG. 5A, for an example of angle of arrival (AoA) estimation, discloses an example network diagram illustrating a relative location along a first axis of the inquiry scanning device and the inquiring device. In embodiments of the invention, the inquiry scanning device transmits the reference data stream based on the information usable for estimating at least a relative direction. The reference data stream transmission from the inquiry scanning device is received by the antenna array at the inquiring device, the antenna array sequentially switching the data stream during reception. The inquiring device receives the reference data stream and decodes the reference data stream to obtain a direction value, based on the extended inquiry response packet with the information usable for estimating at least a relative direction, in accordance with at least one embodiment of the present invention.

FIG. 5B, for an example of angle of arrival (AoA) estimation, discloses an example network diagram illustrating a second relative location along a second axis offset from the first axis, of the inquiry scanning device and the inquiring device. In embodiments of the invention, the inquiry scanning device transmits the reference data stream based on the information usable for estimating at least a relative direction. The reference data stream transmission from the inquiry scanning device is received by the antenna array at the inquiring device, the antenna array sequentially switching the data stream during reception. The inquiring device receives the reference data stream and decodes the reference data stream to obtain a direction value, based on the extended inquiry response packet with the information usable for estimating at least a relative direction, in accordance with at least one embodiment of the present invention.

FIG. 6A, for an example of angle of arrival (AoA) estimation, is an example embodiment of a flow diagram of an example method, from the point of view of the inquiry scanning device receiving a predetermined dedicated inquiry (DIAC) packet, in accordance with at least one embodiment of the present invention.

FIG. 6B, for an example of angle of arrival (AoA) estimation, is an example embodiment of a flow diagram of an example method, from the point of view of the inquiring device transmitting a predetermined dedicated inquiry (DIAC) packet, in accordance with at least one embodiment of the present invention.

FIG. 6C, for an example of angle of arrival (AoA) estimation, is an example embodiment of a flow diagram of an example alternate method, from the point of view of the inquiring device transmitting a predetermined dedicated inquiry (DIAC) packet, in accordance with at least one embodiment of the present invention.

FIG. 7A is an example embodiment of a flow diagram of an example method, from the point of view of the inquiring device transmitting a predetermined dedicated inquiry (DIAC) packet, in accordance with at least one embodiment of the present invention.

FIG. 7B is an example embodiment of a flow diagram of an example method, from the point of view of the inquiry scanning device receiving a predetermined dedicated inquiry (DIAC) packet, in accordance with at least one embodiment of the present invention.

FIG. 7C is an example embodiment of a flow diagram of an example method, from the point of view of the inquiry scanning device first receiving a general inquiry (GIAC) packet before receiving a predetermined dedicated inquiry (DIAC) packet, in accordance with at least one embodiment of the present invention.

FIG. 8 is an example embodiment of a Bluetooth™ Extended Inquiry Response packet.

FIG. 8A is an example embodiment of a Bluetooth™ Tail packet in a backwards compatible format, according to at least one embodiment.

FIG. 8B is an example embodiment of Bluetooth™ extended inquiry response data for tail decoding in a backwards compatible format, according to at least one embodiment.

FIG. 8C is an example embodiment of a Bluetooth™ extended inquiry response payload, for the packet shown in FIGS. 8A and 8B in a backwards compatible format, according to at least one embodiment.

FIG. 9 is an example embodiment of a Bluetooth™ Direction estimation data included within the packet in a backwards compatible format, according to at least one embodiment.

FIG. 10A is an example embodiment of a Bluetooth™ Data type example in a backwards compatible format, according to at least one embodiment.

FIG. 10B is an example embodiment of Bluetooth™ flags bits usage in a backwards compatible format, according to at least one embodiment.

FIG. 11 is an example embodiment of a Bluetooth™ FHS packet format, according to at least one embodiment.

FIG. 12 is a timing diagram of an example embodiment of Bluetooth™ Direction data after FHS packet, according to at least one embodiment.

FIG. 13 is a timing diagram of an example embodiment of Bluetooth™ Direction data after extended inquiry response packet, according to at least one embodiment.

FIG. 14A is an example timing diagram during the inquiry scan state of an inquiry scanning device, after a general inquiry (GIAC) procedure, showing a diagram of transmitted inquiries by the inquiring device in the role of a potential master device in a potential piconet, the diagram of inquiries shown superimposed on a diagram of the inquiry scan intervals of the scanning device in the role of a potential slave in the potential piconet, according to an embodiment of the present invention.

FIG. 14B is an example timing diagram during the inquiry scan state of an inquiry scanning device, after receiving a predetermined dedicated inquiry (DIAC), showing a diagram of transmitted inquiries by the inquiring device, shown superimposed on a diagram of the inquiry scan intervals of the scanning device, wherein the scanning device modifies the Bluetooth™ inquiry scanning procedures for receiving inquiry signals, by increasing the duration of the scan window in response to the receipt of a predetermined dedicated inquiry (DIAC) packet, according to an embodiment of the present invention.

FIG. 14C is an example timing diagram during the inquiry scan state of an inquiry scanning device, after receiving a predetermined dedicated inquiry (DIAC), showing a diagram of transmitted inquiries by the inquiring device, shown superimposed on a diagram of the inquiry scan intervals of the scanning device, wherein the scanning device modifies the Bluetooth™ inquiry scanning procedures for receiving inquiry signals, by decreasing the duration of the scan interval between scans in response to the receipt of a predetermined dedicated inquiry (DIAC) packet, according to an embodiment of the present invention.

### DISCUSSION OF EXAMPLE EMBODIMENTS OF THE INVENTION

This section is organized into the following topics:

A. Terminology

B. Connection Formation Between Bluetooth™ Devices

C. Direction Estimation Between Bluetooth™ Devices

D. Direction Estimation Using An Extended Inquiry Response Packet
1. Examples of Angle of Departure (AoD) Estimation,
2. Examples of Angle of Arrival (AoA) Estimation

E. Examples of Processing the Predetermined dedicated Inquiry (DIAC) Packet

F. Formatting Examples for the Extended Inquiry Response Packet

G. Examples of Modifying the Inquiry Scanning Procedures

### A. TERMINOLOGY

The term “angle of departure (AoD)”, as used herein, is employed with reference to an array of antennas arranged with a normal axis. A normal axis perpendicular to a linear axis defines a plane with the linear antenna array. The apparent direction of transmission of a signal from the linear antenna array, as seen from a remote receiving device occupying the plane, may be represented by an observation vector. The angle between the observation vector and the normal axis is defined as the angle of departure (AoD) of the signal as it leaves the antenna array. In embodiments, the antenna array may be arranged in a two-dimensional array in a plane and the normal axis is perpendicular to the plane of the antenna array. In this arrangement, the angle of departure (AoD) is similarly defined as the angle between the observation vector and the normal axis to the plane. In embodiments, the antenna array may be arranged in any arbitrary manner, either in a linear array, a two-dimensional array, or a three dimensional array.

The term “angle of arrival (AoA)”, as used herein, is employed with reference to an array of antennas arranged with a normal axis. A normal axis perpendicular to a linear axis defines a plane with the linear antenna array. The apparent direction of reception of a signal by the linear antenna array, as seen from a remote transmitting device occupying the plane, may be represented by an observation vector. The angle between the observation vector and the normal axis is defined as the angle of arrival (AoA) of the signal as it approaches the antenna array. In embodiments, the antenna array may be arranged in a two-dimensional array in a plane and the normal axis is perpendicular to the plane of the antenna array. In this arrangement, the angle of arrival (AoA) is similarly defined as the angle between the observation vector and the normal axis to the plane. In embodiments, the antenna array may be arranged in any arbitrary manner, either in a linear array, a two-dimensional array, or a three dimensional array.

The term “special DIAC”, as used herein, is a special value reserved for the inquiry access code (IAC), to signify that an inquiring device that transmits the special DIAC is capable of receiving and using information usable for estimating at least a relative direction, for direction estimation, in accordance with example embodiments of the invention. An inquiry scanning device that recognizes the special DIAC is capable of generating and transmitting such information, in accordance with example embodiments of the invention described herein. If an inquiry scanning device is capable of recognizing the new, specially reserved value for the special DIAC when it receives an inquiry packet from an inquiring device, the scanning device will respond by generating and transmitting the information usable for estimating at least a relative direction, as described herein, in accordance with example embodiments of the invention. The inquiring device will use the received information usable for estimating at least a relative direction, for direction estimation. If the inquiry scanning device has one or more antennas for transmitting the information usable for estimating at least a relative direction and the inquiring device has an antenna array for receiving the information usable for estimating at least a relative direction, then the receiving, inquiring device will estimate the angle of arrival (AoA) with respect to itself, in accordance with example embodiments of the invention. Alternately, if the inquiry scanning device has an antenna array to transmit the information usable for estimating at least a relative direction and the inquiring device has one or more antennas to receive the information usable for estimating at least a relative direction, then the receiving, inquiring device will estimate the angle of departure (AoD) with respect to the transmitter, in accordance with example embodiments of the invention. In embodiments of the invention, two special values may be reserved for the inquiry access code, one for estimating the angle of arrival (AoA) and another for estimating the angle of departure (AoD).

The term “location enhanced Bluetooth™ device”, as used herein, refers to any device, whether portable or fixed-base, that is capable generating or utilizing the information usable for estimating at least a relative direction, as described herein, in response to respectively receiving or transmitting the specially reserved value for the special DIAC in a Bluetooth™ inquiry packet, in accordance with example embodiments of the invention.

The terms “positioning” and “direction estimation”, as used herein, are used interchangeably herein to refer to determining an angle of departure estimation, an angle of arrival estimation, or both.

### B. CONNECTION FORMATION BETWEEN BLUETOOTH™ DEVICES

A procedure for forming connections between Bluetooth™ devices is described in the Bluetooth™ Specification, Version 4, Jun. 30, 2010. The Bluetooth™ Baseband is the part of the Bluetooth™ system that implements the Media Access Control (MAC) and physical layer procedures to support the connection formation, exchange of data information streams, and ad hoc networking between Bluetooth™ devices. Connection formation includes inquiry, inquiry scanning, inquiry response, paging, page scanning, and page response procedures.

1. Inquiry

Inquiry is a procedure where a Bluetooth™ device transmits inquiry messages and listens for responses in order to discover the other Bluetooth™ devices that are within the coverage area. Bluetooth™ devices use the inquiry procedure to discover nearby devices, or to be discovered by devices in their locality. A Bluetooth™ device that tries to find other nearby devices is known as an inquiring device and actively sends inquiry requests. Bluetooth™ devices that are available to be found are known as discoverable devices, listen or scan for these inquiry requests, and send responses. The inquiry procedure uses dedicated physical channels for the inquiry requests and responses. The inquiry procedure does not make use of any of the architectural layers above the physical channel, although a transient physical link may be considered to be present during the exchange of inquiry and inquiry response information.

Bluetooth™ devices communicate with one another over a total bandwidth of 80 MHz divided into 79 physical channels of 1 MHz each. An inquiring device wanting to discover other devices repetitively probes a first set of 16 frequencies, probing two frequencies every 625 microseconds. It repeats this at least 256 times. Then, it repetitively probes a second set of 16 frequencies. The inquiring device will repeat entire cycle at least two times. Of the 79 radio carriers, 32 are considered wake-up carriers and the inquiring device broadcasts inquiry packets on these 32 carrier frequencies.

During the inquiry procedure, the inquiring device or master transmits inquiry messages with the general or dedicated inquiry access code. The timing for inquiry is the same as for paging. The identity or ID packet consists of the inquiry access code (IAC). It has a fixed length of 68 bits. The receiver uses a bit correlator to match the received packet to the known bit sequence of the ID packet. In order to discover other devices a device may enter inquiry substate. In this substate, it may repeatedly transmit the inquiry message (ID packet) at different hop frequencies. The inquiry hop sequence is derived from the Lower Address Part (LAP) of the General Inquiry Access Code (GIAC). Thus, even when dedicated inquiry access codes (DIACs) are used, the applied hopping sequence is generated from the GIAC LAP. A device that allows itself to be discovered, may regularly enter the inquiry scan substate to respond to inquiry messages. The inquiry response is optional: a device is not forced to respond to an inquiry message. During the inquiry substate, the discovering device collects the Bluetooth™ device addresses and clocks of all devices that respond to the inquiry message. In addition, the discovering device also collects extended information (e.g. local name and supported services) from devices that respond with an extended inquiry response packet. It may then, if desired, make a connection to any one of the discovered devices by means of the page procedure described below. The inquiry message broadcast by the source does not contain any information about the source. However, it may indicate which class of devices should respond. There is one general inquiry access code (GIAC) to inquire for any device, and 63 values have been reserved as dedicated inquiry access codes (DIAC) that only inquire for a certain type of device. The inquiry access codes are derived from reserved Bluetooth™ device addresses. There is only one DIAC defined in the Bluetooth™ Specification, and it is called the Limited Inquiry Access Code (LIAC). The LIAC is only intended to be used for limited time periods in scenarios where both devices have been explicitly caused to enter this state, usually by user action.

Inquiry scan is a procedure where a Bluetooth™ device listens for inquiry messages received on its inquiry scan physical channel. A device using one of its inquiry scan channels remains passive on that channel until it receives an inquiry message on this channel from another Bluetooth™ device. This is identified by the appropriate inquiry access code. The inquiry scanning device will then follow the inquiry response procedure to return a response to the inquiring device. The inquiry scan substate is very similar to the page scan substate. However, instead of scanning for the device's device access code, the receiver may scan for the inquiry access code long enough to completely scan for 16 inquiry frequencies. The inquiry procedure uses 32 dedicated inquiry hop frequencies according to the inquiry hopping sequence. These frequencies are determined by the general inquiry address. The phase is determined by the native clock of the device carrying out the inquiry scan. Instead of, or in addition to, the general inquiry access code, the device may scan for one or more dedicated inquiry access codes. However, the scanning may follow the inquiry scan hopping sequence determined by the general inquiry address. The inquiry scan interval may be less than or equal to 2.56 s.

2. Inquiry Response

An inquiry response packet (FHS) is transmitted from the inquiry scanning device or slave to the master after the slave has received an inquiry message. This packet contains information necessary for the inquiring master to page the slave and follows 625 microseconds after the receipt of the inquiry message. The inquiry response packet is received by the master at the hop frequency when the inquiry message received by the slave was first in the master-to-slave slot. The slave response substate for inquiries differs completely from the slave response substate applied for pages. When the inquiry message is received in the inquiry scan substate, the recipient may return an inquiry response (FHS) packet containing the recipient's device address (BD_ADDR) and other parameters. If the recipient has non-zero extended inquiry response data to send, it may return an extended inquiry response packet after the FHS packet. On the first inquiry message received in the inquiry scan substate the slave may enter the inquiry response substate. If the slave has non-zero extended inquiry response data to send it may return an FHS packet, with the extended inquiry response bit set to one, to the master 625 microseconds after the inquiry message was received. It may then return an extended inquiry response packet 1250 microseconds after the start of the FHS packet. If the slave's extended inquiry response data is all zeroes the slave may only return an FHS packet with the extended inquiry response bit set to zero.

A contention problem could arise when several devices are in close proximity to the inquiring device or master and all respond to an inquiry message at the same time. However, because every device has a free running clock it is highly unlikely that they all use the same phase of the inquiry hopping sequence. In order to avoid repeated collisions between devices that wake up in the same inquiry hop channel simultaneously, a device will back-off for a random period of time. Thus, if the device receives an inquiry message and returns an FHS packet, it will generate a random number, RAND, between 0 and MAX_RAND. For scanning intervals greater than or equal to 1.28 seconds MAX_RAND will be 1023, however, for scanning intervals less than 1.28 s MAX_RAND may be as small as 127. A profile that uses a DIAC may choose to use a smaller MAX_RAND than 1023 even when the scanning interval is greater than or equal to 1.28 s. The slave will return to the CONNECTION or STANDBY state for the duration of at least RAND time slots. Before returning to the CONNECTION and STANDBY state, the device may go through the page scan substate. After at least RAND slots, the device will add an offset of 1 to the phase in the inquiry hop sequence (the phase has a 1.28 second resolution) and return to the inquiry scan substate again. If the slave is triggered again, it will repeat the procedure using a new RAND. The offset to the clock accumulates each time an FHS packet is returned. During a period when the inquiry device is broadcasting inquiry packets, a slave may respond multiple times, but on different frequencies and at different times. Reserved synchronous slots should have priority over response packets; that is, if a response packet overlaps with a reserved synchronous slot, it will not be sent, but the next inquiry message is awaited. If a device has extended inquiry response data to send, but the extended inquiry response packet overlaps with a reserved synchronous slot, the FHS packet may be sent with the EIR bit set to zero.

The messaging during the inquiry routines is summarized as follows:

In step 1, the master transmits an inquiry message using the inquiry access code and its own clock.

In step 2, the slave responds with the FHS packet containing the slave's Bluetooth™ device address, native clock and other slave information. This FHS packet is returned at times that tend to be random. The FHS packet is not acknowledged in the inquiry routine, but it is retransmitted at other times and frequencies as long as the master is probing with inquiry messages.

In step 3, if the slave has non-zero extended inquiry response data, it sends an extended inquiry response packet to the master.

3. Extended Inquiry Response

An Extended Inquiry Response may be used to provide miscellaneous information during the inquiry response procedure. Data types are defined for such things as local name and supported services, information that otherwise would have to be obtained by establishing a connection. A device that receives a local name and a list of supported services in an extended inquiry response does not have to connect to do a remote name request and a service discovery protocol (SDP) service search, thereby shortening the time to useful information. If the slave transmits an extended inquiry response packet, it is transmitted 1250 microseconds after the start of the inquiry response packet. The extended inquiry response packet is received by the master at the hop frequency when the inquiry message received by the slave was first in the master-to-slave slot. The extended inquiry response packet is an Asynchronous Connection-oriented Logical transport (ACL) packet with type DM1, DM3, DM5, DH1, DH3 or DH5. To minimize interference it is recommended to use the shortest packet that is capable of containing the data. The packet is sent on the same frequency as the FHS packet, 1250 microseconds after the start of the FHS packet. In the packet header, LT_ADDR may be set to zero. TYPE may be one of DM1, DM3, DM5, DH1, DH3 or DH5. FLOW, ARQN and SEQN may all be set to zero and ignored during receipt. The HEC LFSR may be initialized with the same DCI (default check initialization) as for the FHS packet. In the payload header, LLID may contain the value 10 (start of an L2CAP message or no fragmentation). FLOW may be set to zero and ignored upon receipt. The length of the payload body (LENGTH) may be smaller than or equal to 240 bytes. The CRC LFSR may be initialized with the same DCI as for the FHS packet. The data whitening LFSR may be initialized with the same value as for the FHS packet. The length of the payload body (LENGTH) may be smaller than or equal to 240 bytes. The CRC LFSR may be initialized with the same DCI as for the FHS packet. The data whitening LFSR may be initialized with the same value as for the FHS packet. The payload data has two parts, a significant part followed by a non-significant part. The significant part contains a sequence of data structures. The non-significant part contains all zero octets. The baseband may not change any octets in the significant part. When transmitting data, the non-significant part octets may be omitted from the payload. A device may store a single extended inquiry response packet. This packet may be used with all IACs.

4. Page

Page is the initial phase of the connection procedure where a device transmits a train of page messages until a response is received from the target device or a timeout occurs. Page scan is a procedure where a device listens for page messages received on its page scan physical channel. In forming a connection, the paging device will become the master and the page scan device will become the slave in a piconet. Initially, after the slave has received an inquiry message, an inquiry response packet is transmitted from the slave to the master. The inquiry response packet sent from the slave contains information necessary for the inquiring master to page the slave, such as Bluetooth™ device address and the clock of the slave device. In the paging procedure, one the Bluetooth™ device that will become the master carries out a page procedure by transmitting page messages in connection request packets to the specified Bluetooth™ slave device that carries out a page scanning procedure to listen for connection request packets from the paging device. A connectable Bluetooth™ device listens for a page request on its page scan channel and, once received, enters into a sequence of exchanges with the paging device. In order for a device to connect to another device, it performs frequency hopping all page scan channel frequencies, sending a page request on each frequency and listening for a response. The page scan channel uses an access code derived from the scanning device's Bluetooth™ device address BD_ADDR to identify communications on the channel. The page scan channel uses a slower hopping rate than the hop rate of the paging device, using the Bluetooth™ device clock of the scanning device as an input. A device listening on its page scan channel remains passive until it receives a page request from another Bluetooth™ device, identified by the page scan channel access code. The two devices will then follow the page procedure to form a connection where the paging device is the master and the page scan device is the slave in a piconet. In order for a paging device to connect to another Bluetooth™ device, it uses the page scan channel of the target device in order to send page requests. If the paging device does not know the phase of the target device's page scan channel, it does not know the current hop frequency of the target device. Therefore, the paging device transmits page requests on each of the page scan hop frequencies and listens for a page response. This is done at a faster hop rate, allowing the paging device to cover all page scan frequencies in a short period of time. The paging device may have some knowledge of the target device's Bluetooth™ clock, such as indicated during a previous inquiry transaction between the two devices, and may be able to predict the phase of the target device's page scan channel. It may use this information to optimize the synchronization of the paging and page scanning process and speed up the formation of the connection.

### C. DIRECTION ESTIMATION BETWEEN BLUETOOTH™ DEVICES

Direction estimation of the signal source from the received signal based on multiple antennas has been known for decades and it has been used in professional and military applications for quite some time. The estimation of the angle of arrival is based on time difference of signal copies received by multiple, spatially separated antennas, and the time difference is due to variable propagation channel lengths, and the practical estimation is typically based on secondary effects to the signal, such as the resulting phase difference of the signal copies. However, the known principles have not been applied to consumer devices such as mobile phones due to practical constraints. There is not sufficient space in a small-size handheld device for multiple antennas or multiple receiver signal chains to enable antenna-array reception in a manner described above. The traditional requirements for direction finding explained above can be circumvented with novel, tightly integrated multi-antenna modules placed appropriately on a mobile device, performing very fast antenna switching during a known reference signal. Effectively, if the signal phase change is known apriori based on a known signal, the signal phase differences obtained from different antennas can be used to estimate the direction of arrival of the signal. This implementation approach opens up direction finding possibility for small devices and therefore enables new applications using the directional information.

However, existing packet structures from standardized radios do not necessarily have sufficient signal sequences and appropriate information content properties to enable direction finding. Additionally, appropriate packets are not necessarily exchanged in a useful phase of the communication sequence. Perhaps proprietary direction finding packets transmitted in addition to standard communication packets would provide a solution, but in that case wide industry support and interoperability would not be achieved. Therefore, a standardized solution to providing direction finding signals is needed. Personal area network (PAN) use cases would make the choice of Bluetooth™ technology optimal as a direction finding signal carrier.

Direction finding would be very useful when the user wishes to set up a Bluetooth™ connection to another device. The ability of the user's inquiring device to display on the user's device screen the direction of an inquiry scanning device prior to making a connection, would give the user confirmation that the proposed connection will be to the intended device and would improve the user's experience. According to the current Bluetooth™ specification, devices are only able to estimate the distance to another device during the inquiry state, based on the received signal power. However, it is not currently possible to obtain the direction of the inquiry scanning device because Bluetooth™ does not provide appropriate signal sequences in the packets exchanged during the inquiry process.

### D. DIRECTION ESTIMATION USING AN EXTENDED INQUIRY RESPONSE PACKET

In example embodiments of the invention, an example reservation of a new, special value for the special DIAC is shown in the following Table 1. If an inquiry scanning device is capable of recognizing the new, specially reserved value for the special DIAC when it receives an inquiry packet from an inquiring device, the scanning device will respond by generating and transmitting the information usable for estimating at least a relative direction, as described herein, in accordance with example embodiments of the invention. The inquiring device will use the received information usable for estimating at least a relative direction, for direction estimation. If the inquiry scanning device has one or more antennas for transmitting the information usable for estimating at least a relative direction and the inquiring device has an antenna array for receiving the information usable for estimating at least a relative direction, then the receiving, inquiring device will estimate the angle of arrival (AoA) with respect to itself, in accordance with example embodiments of the invention. Alternately, if the inquiry scanning device has an antenna array to transmit the information usable for estimating at least a relative direction and the inquiring device has one or more antennas to receive the information usable for estimating at least a relative direction, then the receiving, inquiring device will estimate the angle of departure (AoD) with respect to the transmitter, in accordance with example embodiments of the invention. In embodiments of the invention, two special values may be reserved for the inquiry access code, one for estimating the angle of arrival (AoA) and another for estimating the angle of departure (AoD).

TABLE 1
Reserved values for the inquiry access code (IAC)

| # | LAP value | Usage |
|---|---|---|
| 0 | 0x9E8B33 | General/Unlimited Inquiry Access Code (GIAC) |
| 1 | 0x9E8B00 | Limited Predetermined dedicated inquiry |
| | | Access Code (LIAC) |
| 2 | 0x9E8B01 | New special DIAC for direction estimation (DIAC) |
| 3-63 | 0x9E8B02- | RESERVED FOR FUTURE USE |
| | 0x9E8B32 | |

### 1. EXAMPLES OF ANGLE OF DEPARTURE (AoD) ESTIMATION

The term “angle of departure (AoD)”, as used herein, is employed with reference to an array of antennas arranged with a normal axis. A normal axis perpendicular to a linear axis defines a plane with the linear antenna array. The apparent direction of transmission of a signal from the linear antenna array, as seen from a remote receiving device occupying the plane, may be represented by an observation vector. The angle between the observation vector and the normal axis is defined as the angle of departure (AoD) of the signal as it leaves the antenna array. In embodiments, the antenna array may be arranged in a two-dimensional array in a plane and the normal axis is perpendicular to the plane of the antenna array. In this arrangement, the angle of departure (AoD) is similarly defined as the angle between the observation vector and the normal axis to the plane. In embodiments, the antenna array may be arranged in any arbitrary manner, either in a linear array, a two-dimensional array, or a three dimensional array.

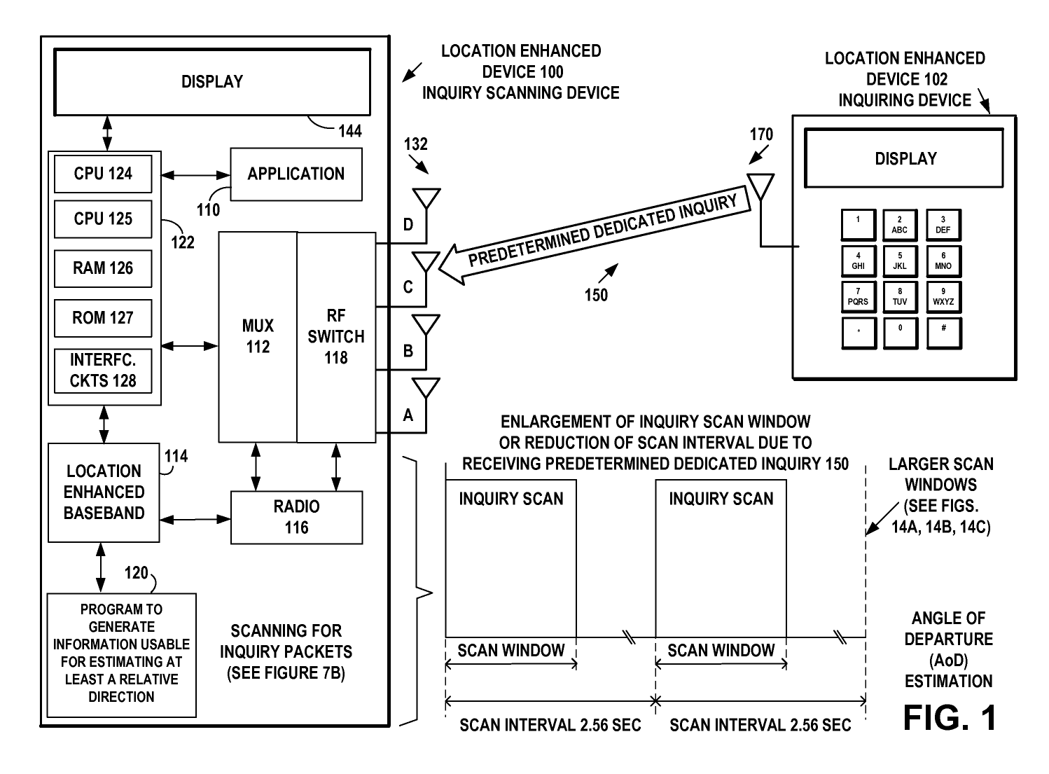

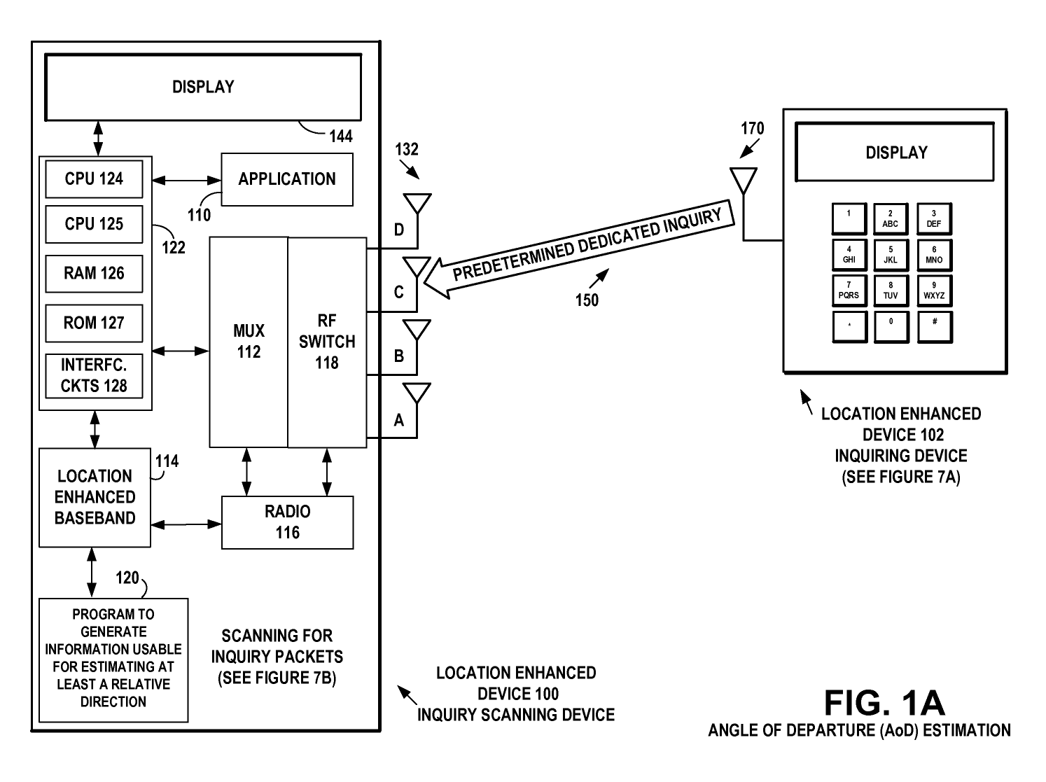

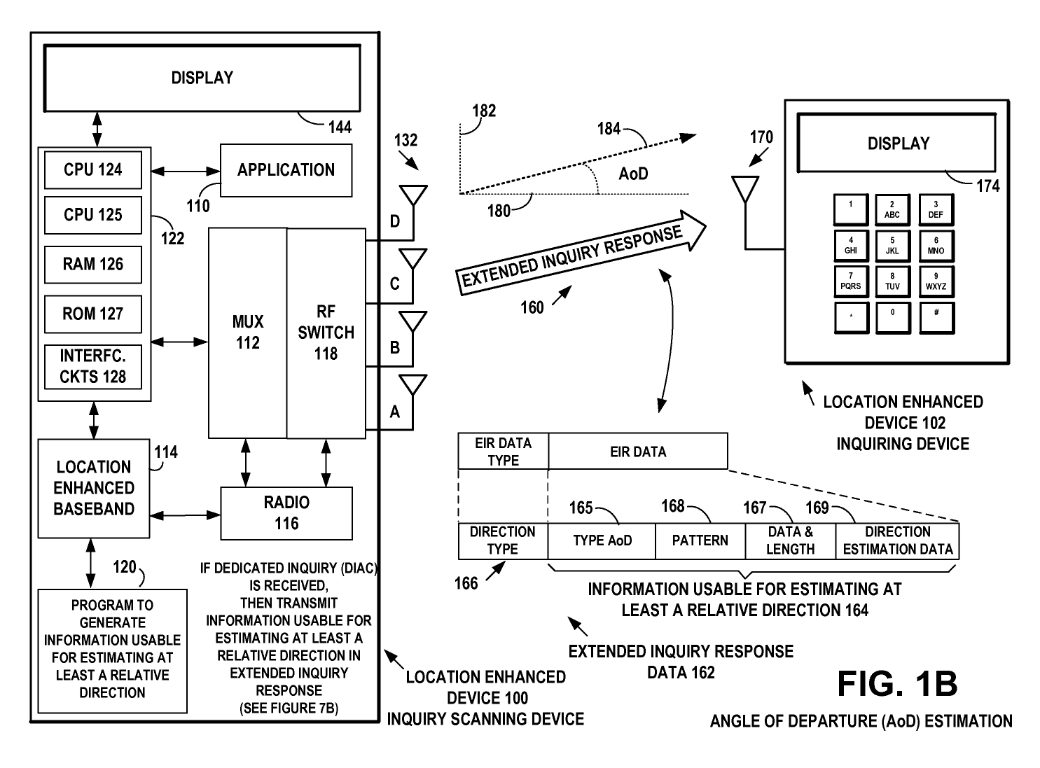

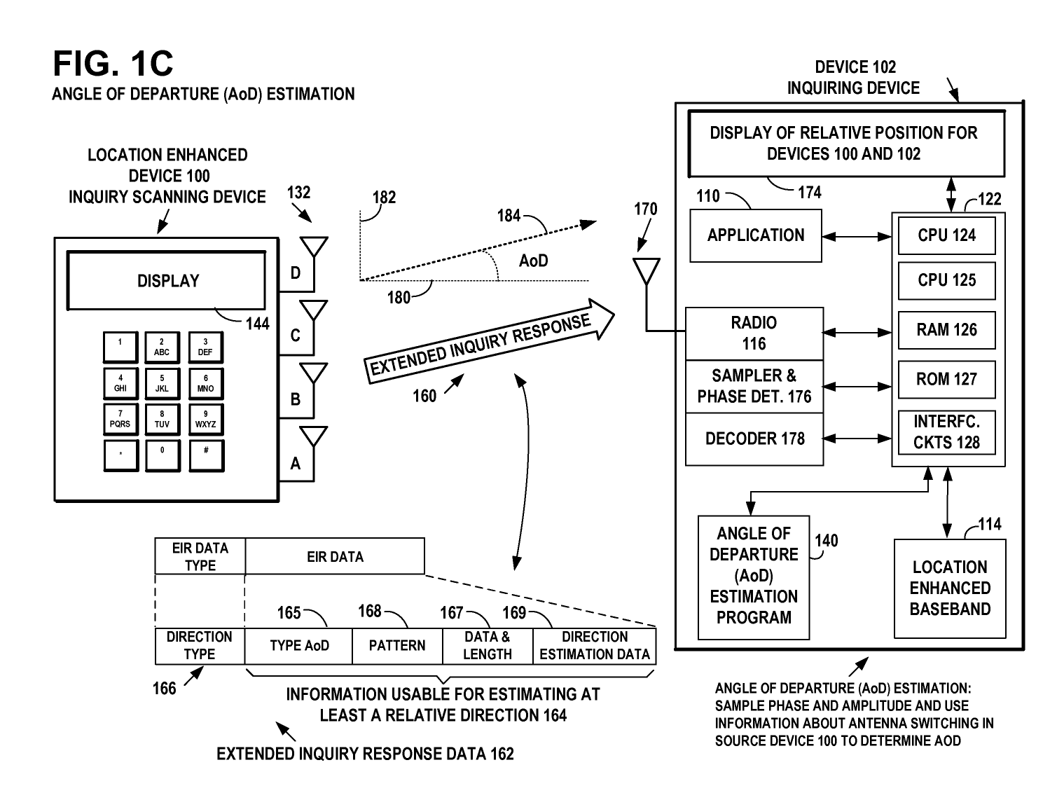

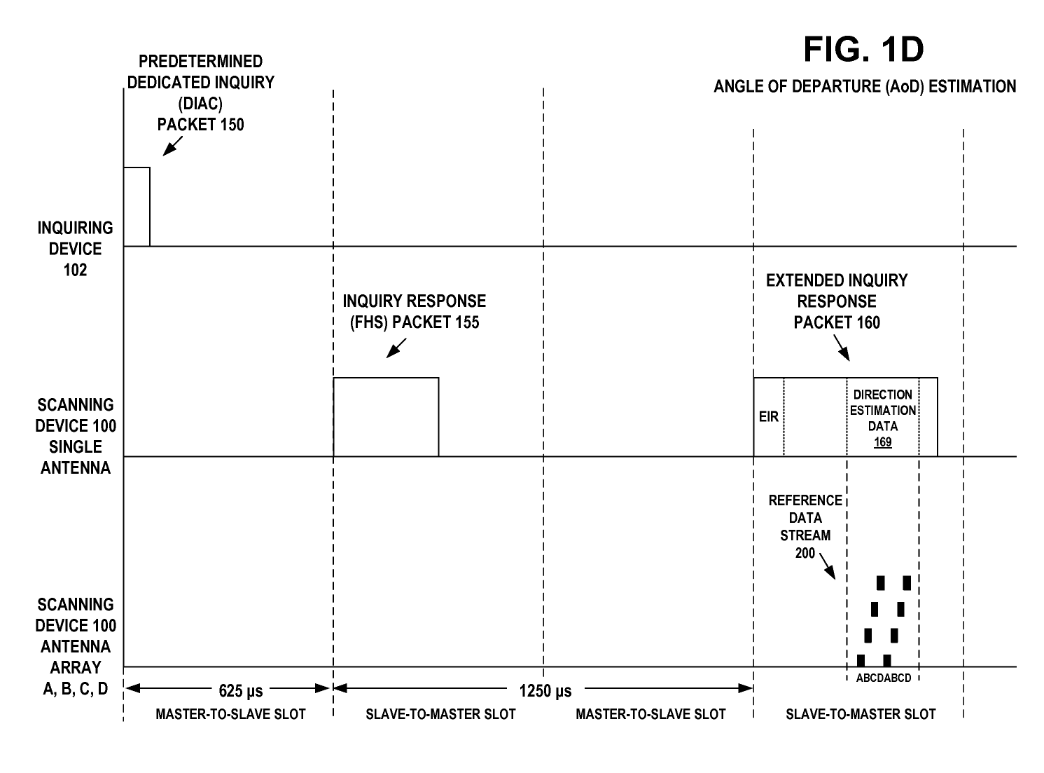

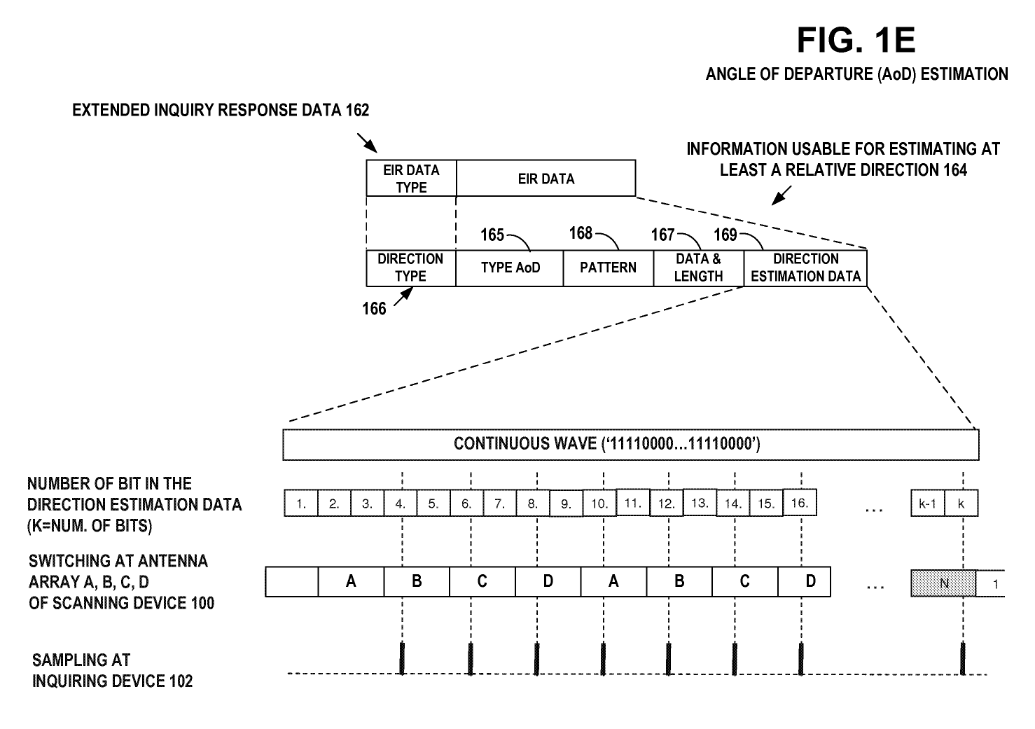

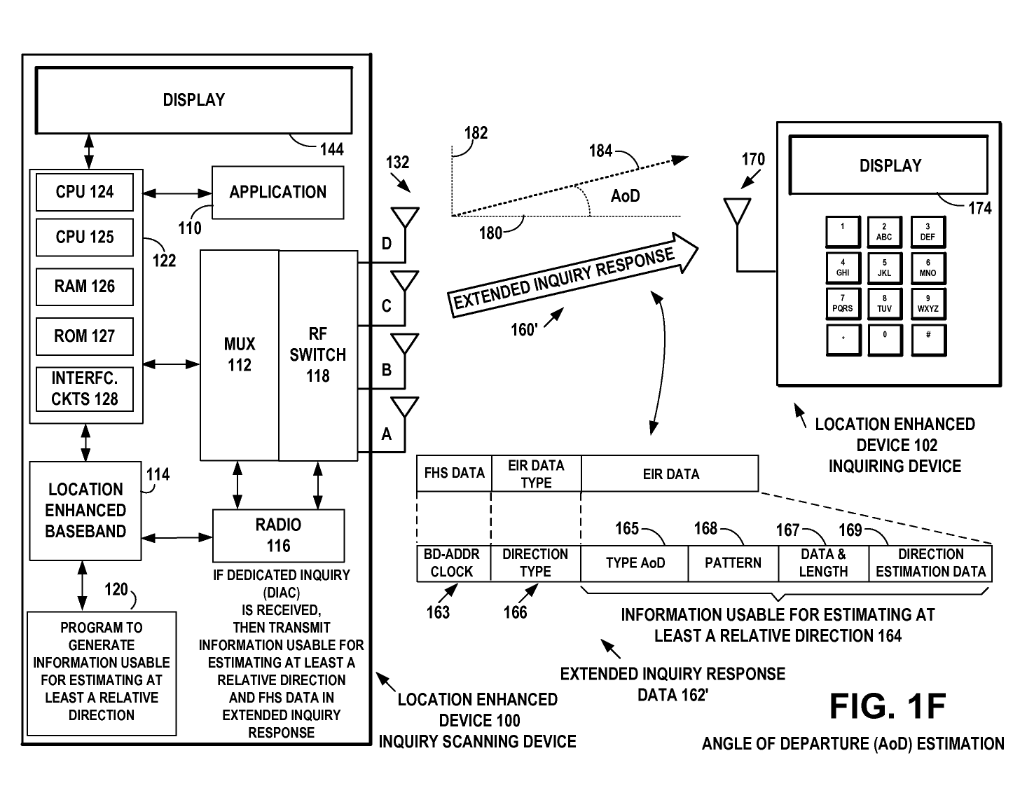

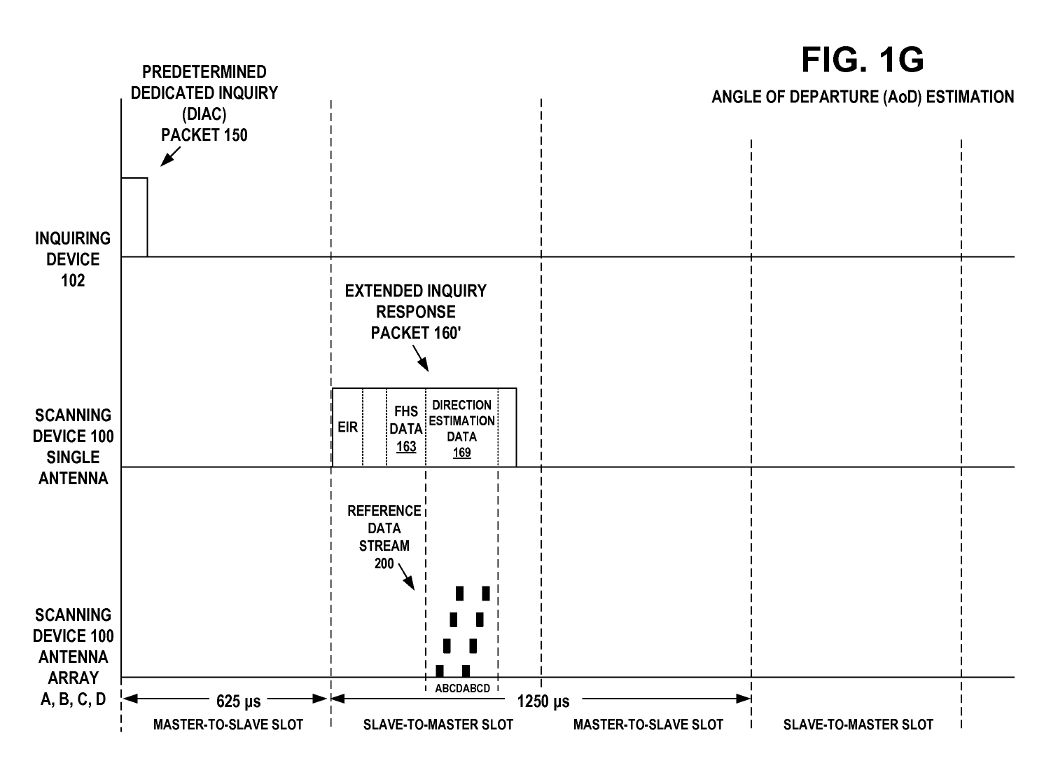

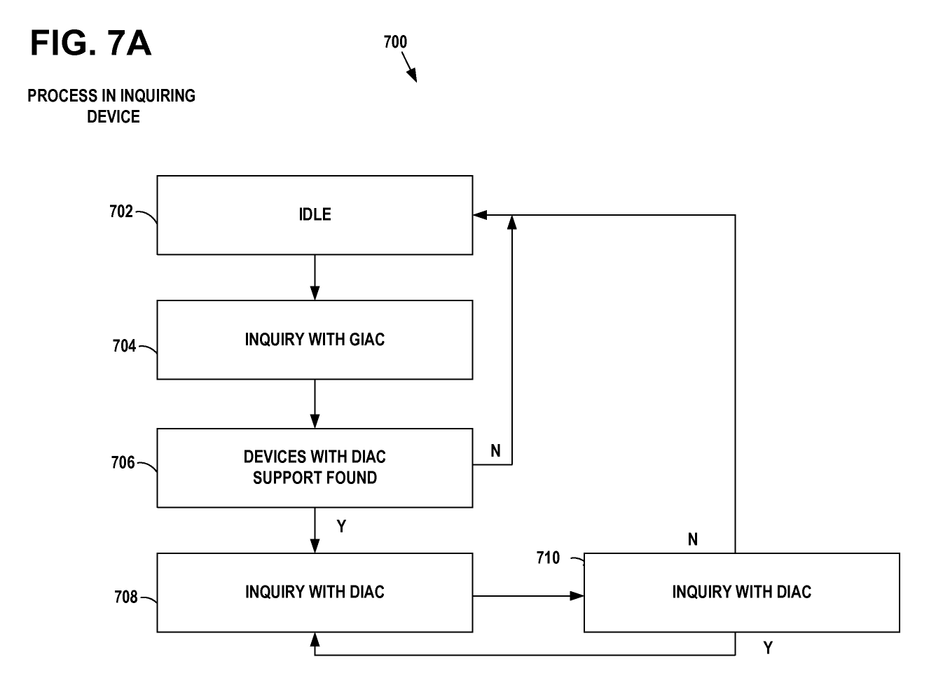

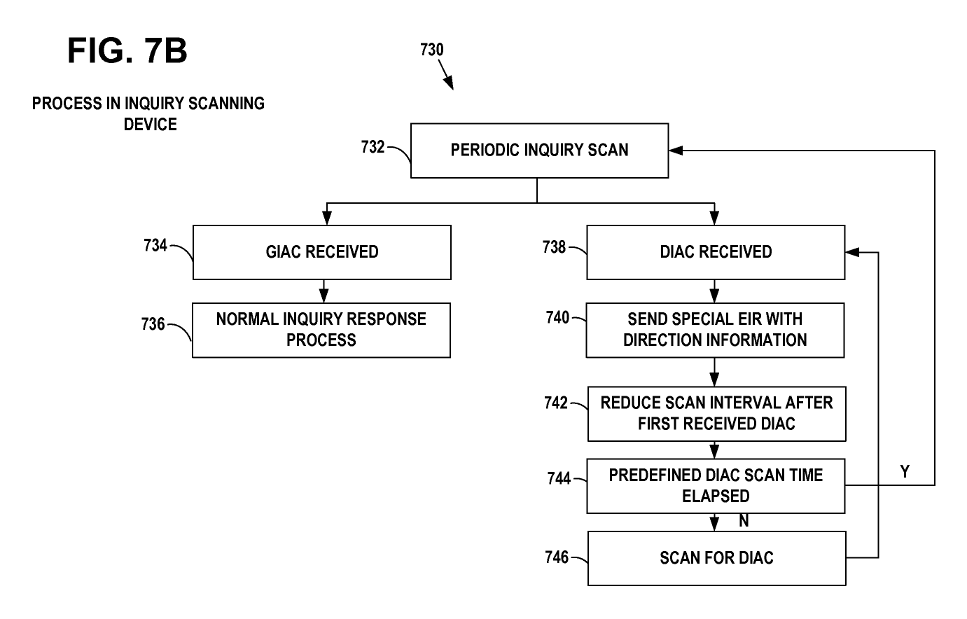

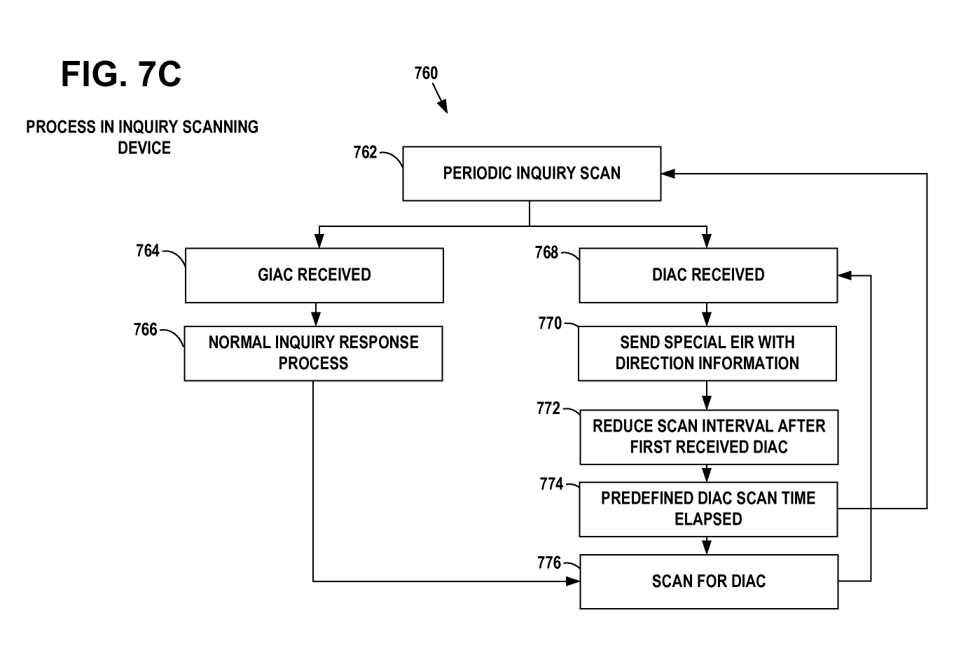

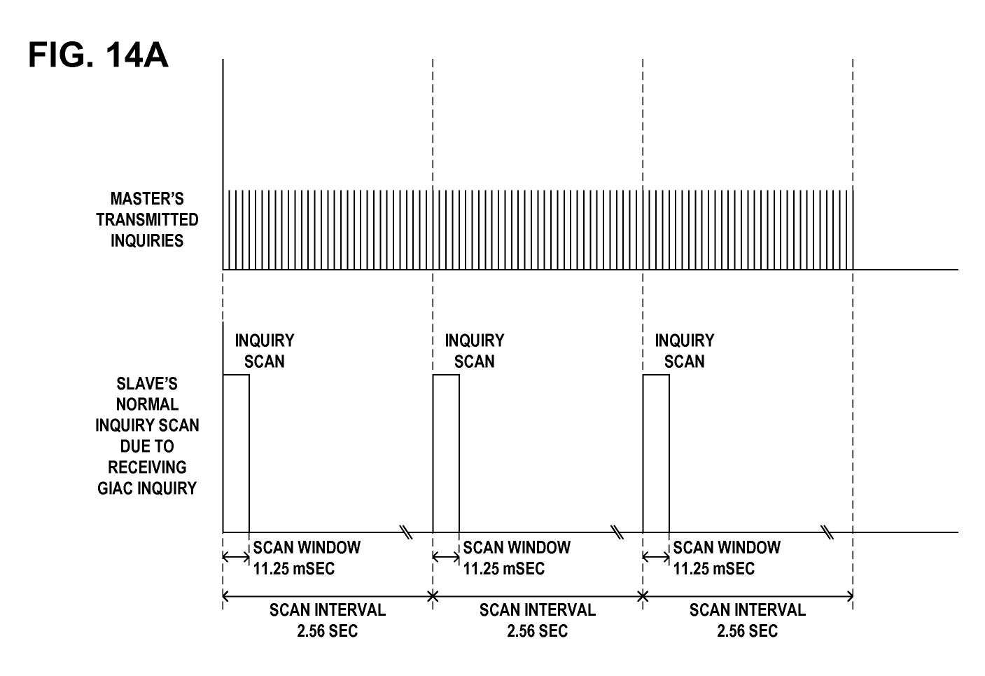

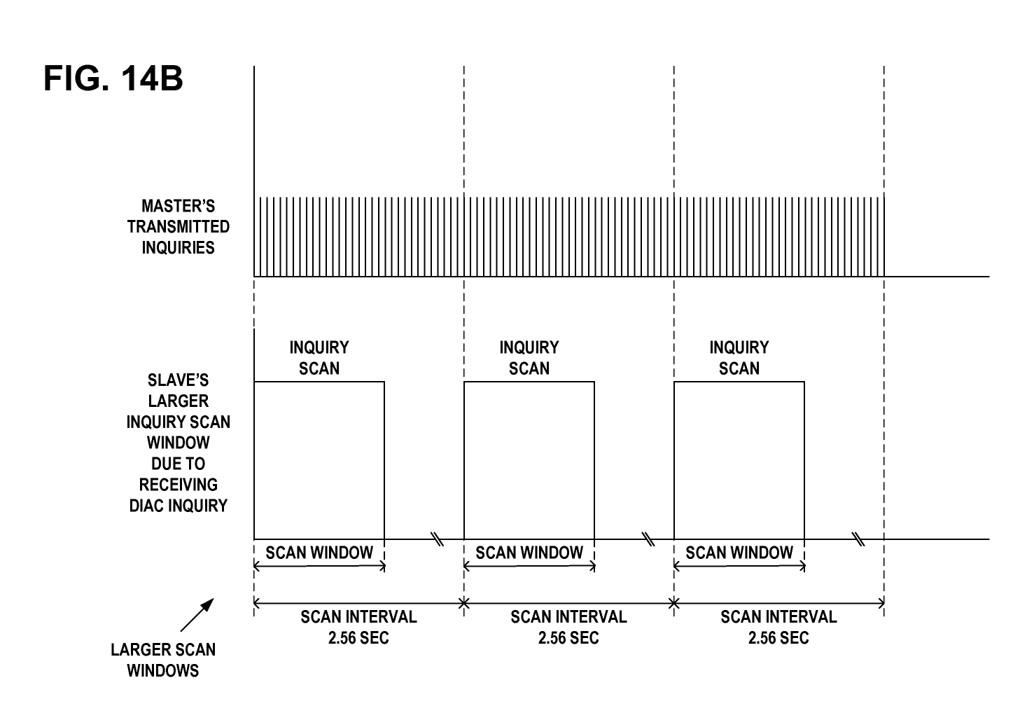

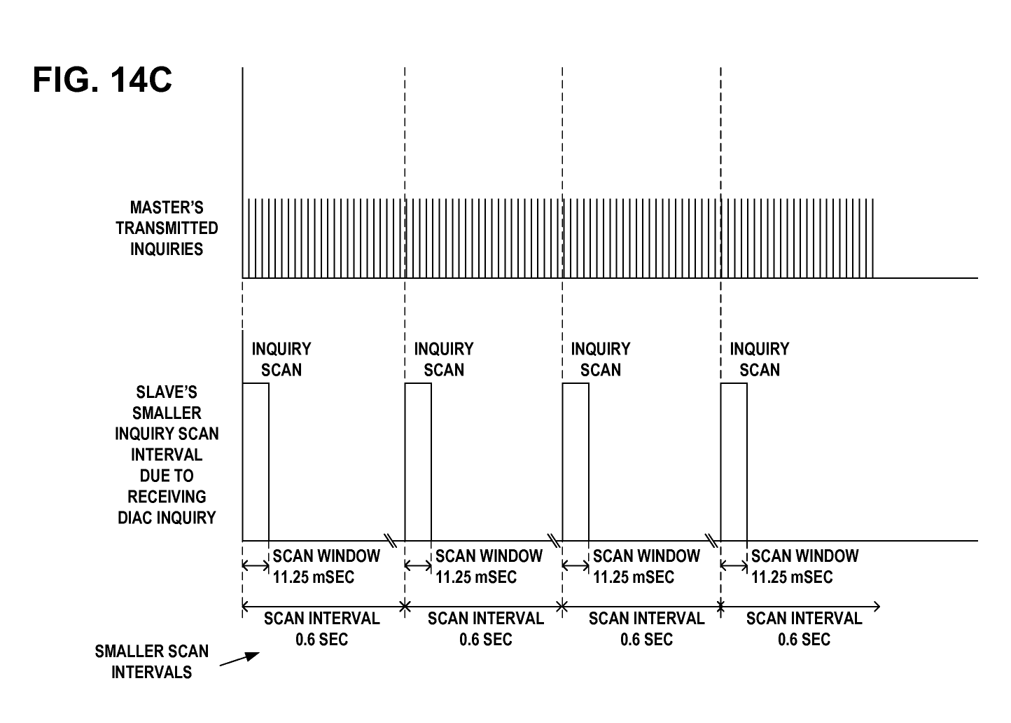

FIG. 1, for an example of angle of departure (AoD) estimation, discloses a location enhanced Bluetooth™ device 100 in inquiry scanning mode, receiving a predetermined dedicated inquiry (DIAC) packet 150 from another Bluetooth™ device 102, and in response, modifying its device detection procedure to improve detection of inquiry signals, by either enlarging the inquiry scan window or reducing the interval between scans, in accordance with at least one embodiment of the present invention. See FIG. 14B for a more detailed depiction of the operation of increasing the duration of the scan window. Alternately, during the inquiry scan state of an inquiry scanning device 100, after receiving a predetermined dedicated inquiry (DIAC) 150, the scanning device 100 modifies the Bluetooth™ inquiry scanning procedures for receiving inquiry signals, by decreasing the duration of the scan interval between scans in response to the receipt of the predetermined dedicated inquiry (DIAC) packet 150, as shown in the flow diagram of FIG. 7B, step 742. See FIG. 14C for a more detailed depiction of the operation of decreasing the duration of the scan interval between scans.

Location enhanced Bluetooth™ device 102 may be, for example, a miniature device such as a key fob, smart card, jewelry, or the like. Location enhanced Bluetooth™ device 100 may be, for example, a relatively larger cell phone, smart phone, flip-phone, PDA, graphic pad, or even larger devices such as a laptop computer, desktop computer, kitchen appliance, such as a refrigerator, an automobile dashboard, and the like. Typically, the device 102 will be in the smallest size range that will be limited to a single antenna, due to size constraints, whereas the larger device 100 will have sufficient surface area or volume to support a multiple antenna array, as described herein. However, in embodiments, the relative sizes of devices 100 and 102 may be arbitrary, either one of the devices may be either mobile or fixed-base, and the device 102 may have either a single antenna or an antenna array.

FIG. 1A discloses an example network diagram illustrating a first location enhanced Bluetooth™ device 100 in inquiry scanning mode receiving a predetermined dedicated inquiry (DIAC) packet 150 from a second location enhanced Bluetooth™ device 102 that is a direction finding capable device in inquiry mode, in accordance with at least one embodiment of the present invention. The inquiry procedure uses dedicated physical channels for the inquiry packet 150 requests and responses. During the inquiry procedure, the inquiring device 102 transmits inquiry packets 150 with the predetermined dedicated inquiry access code (DIAC). The inquiry packet 150 consists of the inquiry access code (IAC) and has a fixed length of 68 bits. The inquiry scanning device 100 may use a bit correlator to match the received packet 150 to the known bit sequence of packets. The inquiring device 102 repeatedly transmits the special DIAC inquiry packets 150 at different hop frequencies. The inquiry hop sequence is derived from the Lower Address Part (LAP) of the General Inquiry Access Code (GIAC). Thus, even when Predetermined dedicated inquiry Access Codes (DIACs) are used, the applied hopping sequence is generated from the GIAC LAP. See FIG. 7A of an example flow diagram of an example method, from the point of view of the inquiring device 102 transmitting both GIAC inquiry packets and predetermined dedicated inquiry (DIAC) packets, in accordance with at least one embodiment of the present invention.

An inquiry scanning device 100 that allows itself to be discovered, regularly enters the inquiry scan substate to respond to inquiry packets 150. The inquiry response is optional: a device is not forced to respond to an inquiry packet 150. During the inquiry substate, the inquiring device 102 collects the Bluetooth™ device addresses and clocks of all devices that respond to the inquiry packet 150. In addition, the inquiring device 102 also collects extended information (e.g. local name and supported services) from devices that respond with an extended inquiry response packet 160. The inquiring device 102 may then, if desired, make a connection to any one of the inquiry scanning devices 100 that has responded, by means of the page procedure. The inquiry packet 150 broadcast by the inquiring device 102 signifies that the inquiring device 102, by virtue of transmitting the special DIAC, is capable of receiving and using information usable for estimating at least a relative direction, as described herein. The inquiry scanning device 100, will recognize the special DIAC 150 and, in response, generate and transmit information usable for estimating at least a relative direction. See FIG. 7B of an example flow diagram of an example method, from the point of view of the inquiry scanning device 100 receiving a predetermined dedicated inquiry (DIAC) packet 150, in accordance with at least one embodiment of the present invention.

In embodiments of the invention, the inquiry scanning device 100 includes a processor 122, which includes from one to many central processing units (CPUs) 124 and 125, a random access memory (RAM) 126, a read only memory (ROM) 127, and interface circuits 128 to interface with one or more radio transceivers 116, battery or house power sources, keyboard, display 144, etc. The RAM and ROM can be removable memory devices such as smart cards, SIMs, WIMs, semiconductor memories such as RAM, ROM, PROMS, flash memory devices, etc. The processor 122 in the inquiry scanning device 100 outputs data to the location enhanced Bluetooth™ baseband 114 that packages the data into Bluetooth™ protocol data units (PDU) or packets, such as FHS packets, inquiry response packets, and extended inquiry response packets that are input to the Bluetooth™ PHY radio 116 for normal Bluetooth™ transmission. During normal Bluetooth™ transmission, the multiplexer 112 directs the RF signal from the radio 116 to one of the antennas A, B, C, or D in the antenna array 132 for transmission. The number of antennas in the antenna array is not limited to four, but may be any number suitable for the functions to be performed by embodiments of the invention.

FIG. 1B, for an example of angle of departure (AoD) estimation, discloses the example network diagram of FIG. 1A, of the inquiry scanning device 100 responding to the receipt of the inquiry packet 150 by providing information usable for estimating at least a relative direction 164 and transmitting an extended inquiry response packet 160 in a backwards compatible format, that includes the information usable for estimating at least a relative direction 164, in accordance with at least one embodiment of the present invention. The inquiry scanning device 100 includes the program 120 to generate the information usable for estimating at least a relative direction 164. In embodiments of the invention, in a first transmission interval, the inquiry scanning device 100 transmits the extended inquiry response packet 160 with the information usable for estimating at least a relative direction 164, in a normal Bluetooth™ transmission.

In FIG. 1B, the inquiry scanning device 100 may have a linear antenna array or an arbitrary array 132 to transmit the information usable for estimating at least a relative direction 164 in the extended inquiry response packet 160 and the inquiring device 102 has a single antenna 170 to receive the information usable for estimating at least a relative direction 164. An antenna array may be arranged one, two, or three dimensions. The receiving, inquiring device 102 will estimate the angle of departure (AoD) with respect to the transmitter 100, in accordance with example embodiments of the invention.

In embodiments of the invention, the extended inquiry response data 162 in the extended inquiry response packet 160 includes an indication 166, “Direction Type” that is used to inform the receiving device 102 about the existence and properties of the information usable for estimating at least a relative direction 164.

The information usable for estimating at least a relative direction 164 may include an indication 165 whether the positioning information relates to angle-of-arrival (AoA) positioning information, angle-of-departure (AoD) positioning information, or both types. The information usable for estimating at least a relative direction 164 may include a reference binary bit pattern 168, such as “11110000”. The information usable for estimating at least a relative direction 164 may include a data and length field 167, that includes data such as coding, length of the direction estimation data, properties of the antennas A, B, C, and D, and other factors useful in enabling the inquiring device 102 to estimate a direction. In embodiments of the invention, in the first transmission interval, the inquiry scanning device 100 transmits the extended inquiry response packet 160 in a normal Bluetooth™ transmission, wherein the multiplexer 112 directs the RF signal bearing the extended inquiry response packet 160, from the radio 116 to one of the antennas A, B, C, or D in the antenna array 132 for transmission.

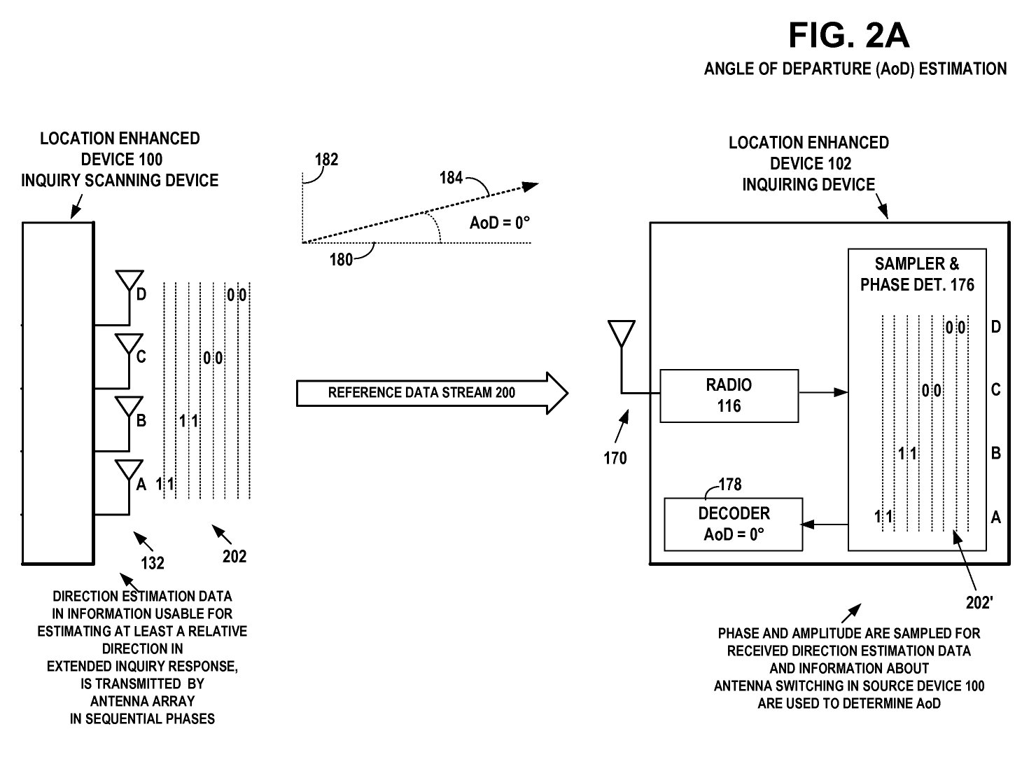

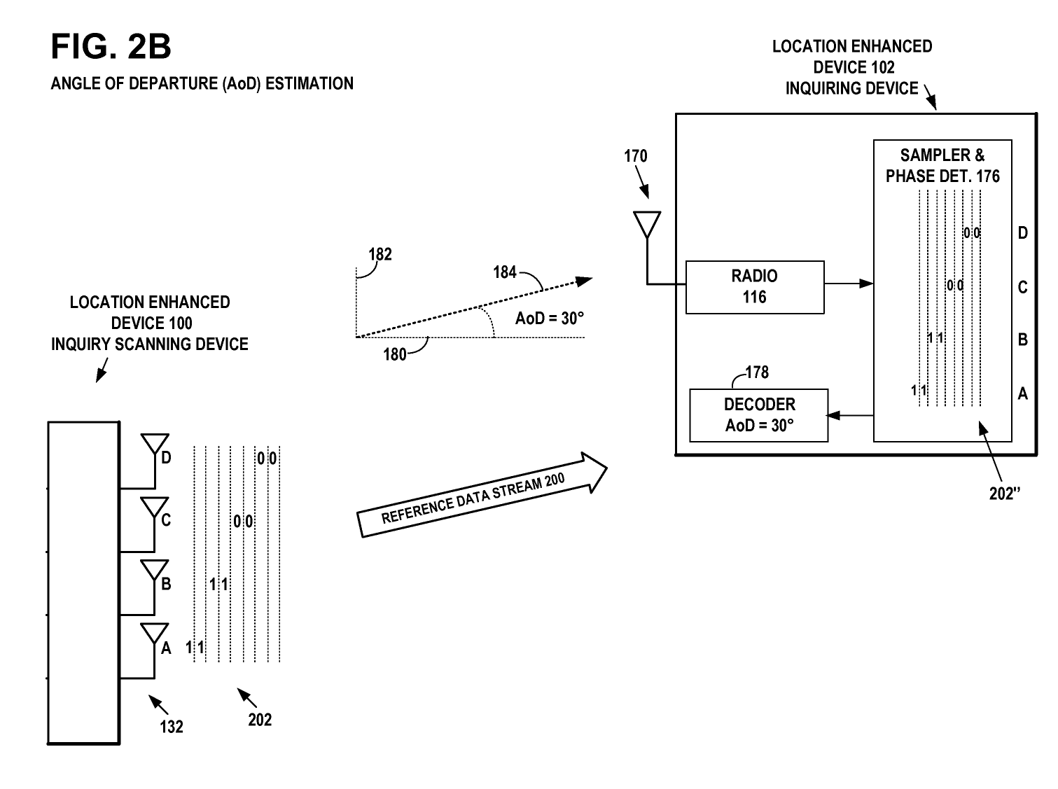

There are several options for the location of the direction estimation data 169, for example in the payload body of the extended inquiry response packet 160 shown in FIG. 1B, in a tail portion following the payload portion of the extended inquiry response packet 160, or in a separate packet that follows the extended inquiry response packet 160. The direction estimation data 169 that may comprise of several concatenated segments of the binary bit pattern 168. In embodiments of the invention, in response to receiving the special DIAC 150, the multiplexer 112 passes the direction estimation data 169 to a commutating RF switch 118 in a second transmission interval, that connects the transmitter of the radio 116 to the antenna array 132 of antennas A, B, C, and D. The commutating RF switch 118 sequentially activates each of the four antennas A, B, C, and D at a commutating frequency to sequentially transmit 2-bit portions of the direction estimation data 169 in a reference data stream 200 shown in FIGS. 2A and 2B, having the repeated reference pattern 168 of bits “11110000”, each 2-bit portion being transmitted in a consecutive phase incremented by an interval. The program 120 to generate the information usable for estimating at least a relative direction 164, generates the reference pattern 168 of bits “11110000” and direction estimation data 169. The direction estimation data 169 in the extended inquiry response 160, is transmitted by antenna array in sequential phases. The four antennas A, B, C, and D of the antenna array 132 are shown in FIGS. 2A and 2B sequentially transmitting the 2-bit portions of the direction estimation data 169 in a reference data stream 200, each 2-bit portion being transmitted in a consecutive phase incremented by a delay interval, thus forming the data stream 200. The 2-bit portions of the direction estimation data 169 in the data stream 200 are only one example embodiment and the portion is not limited to bit intervals but can be arbitrary, also including any fraction or integer number of a bit interval.

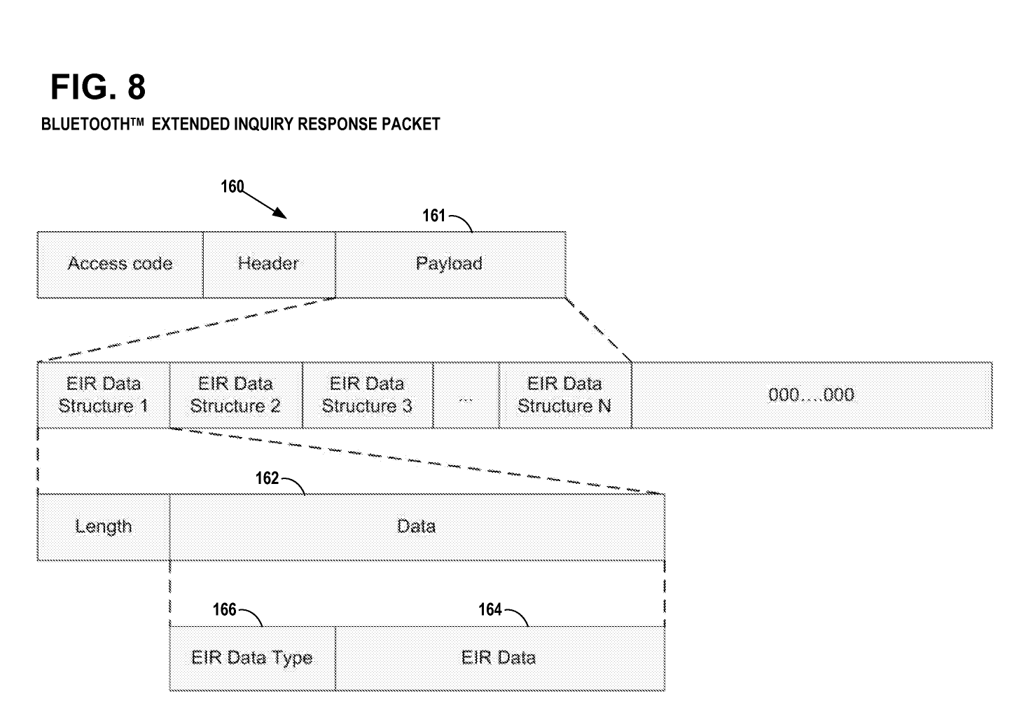

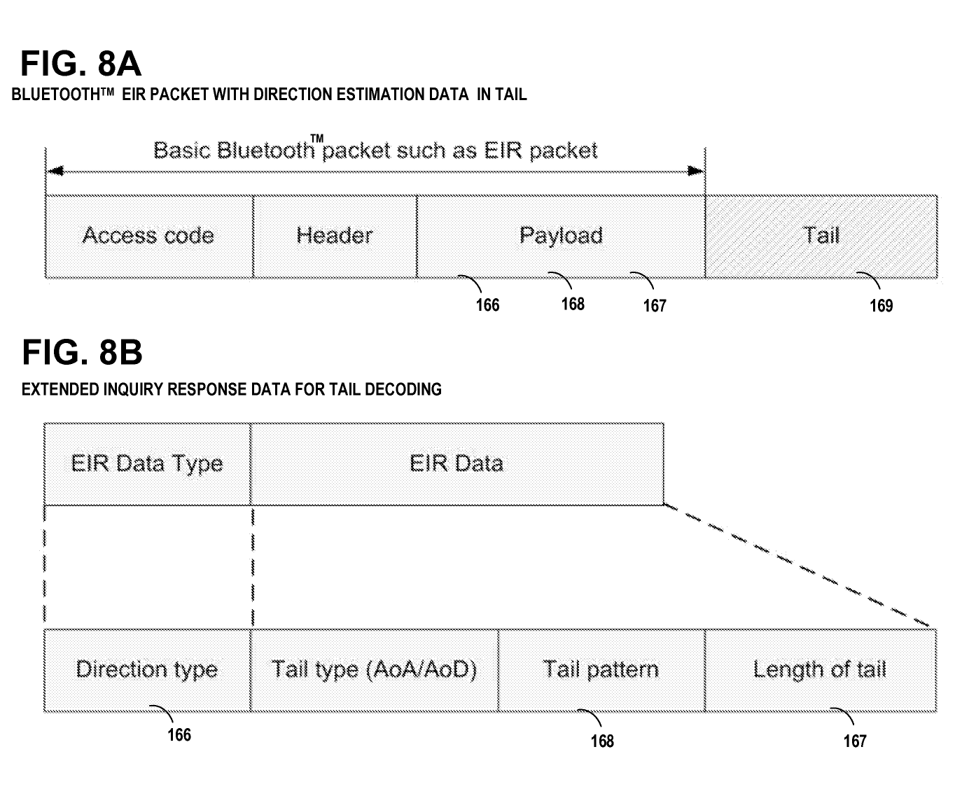

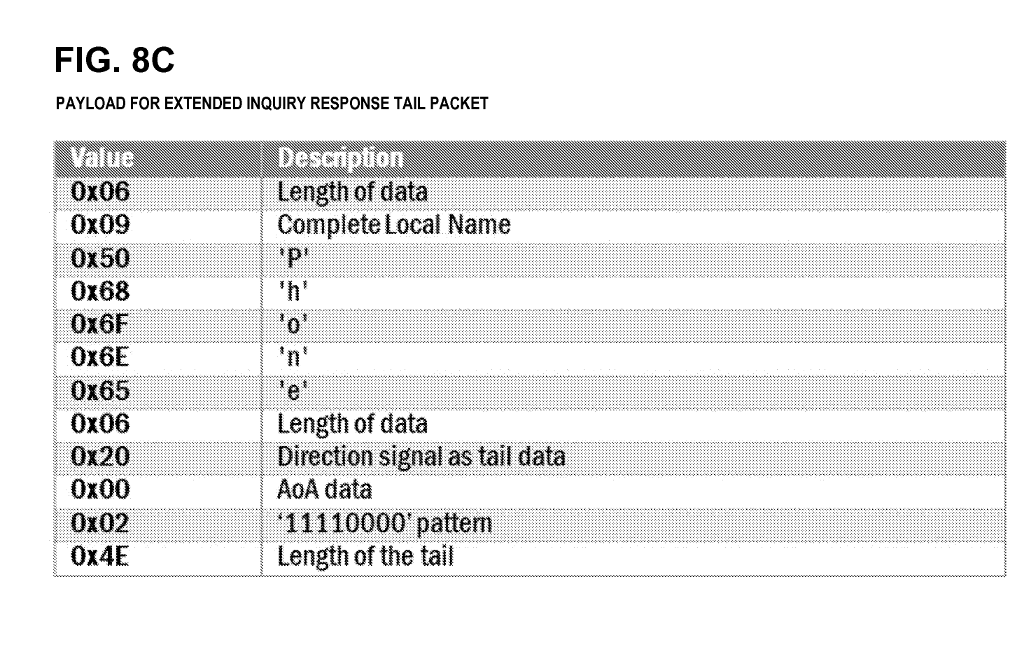

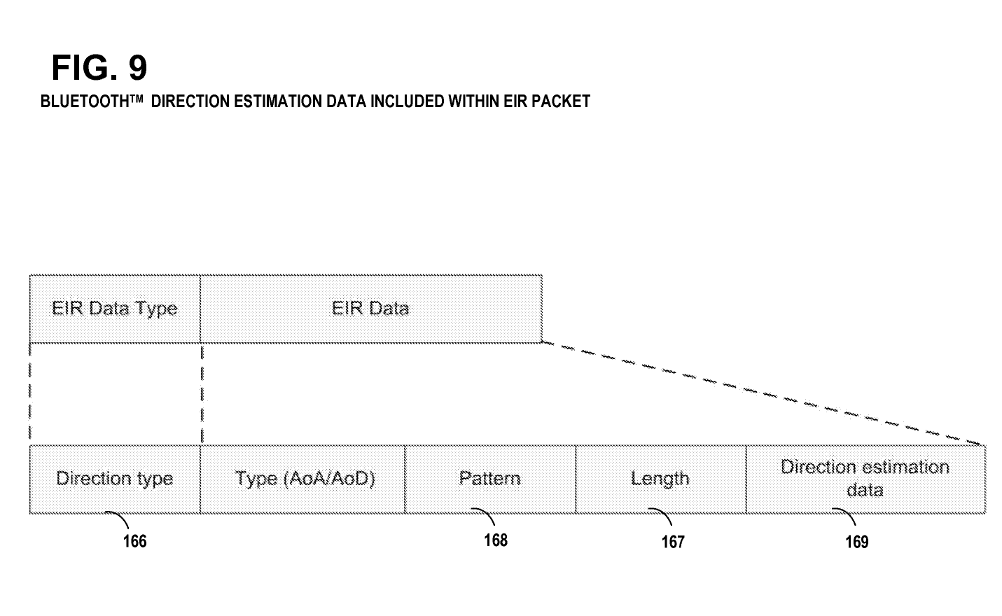

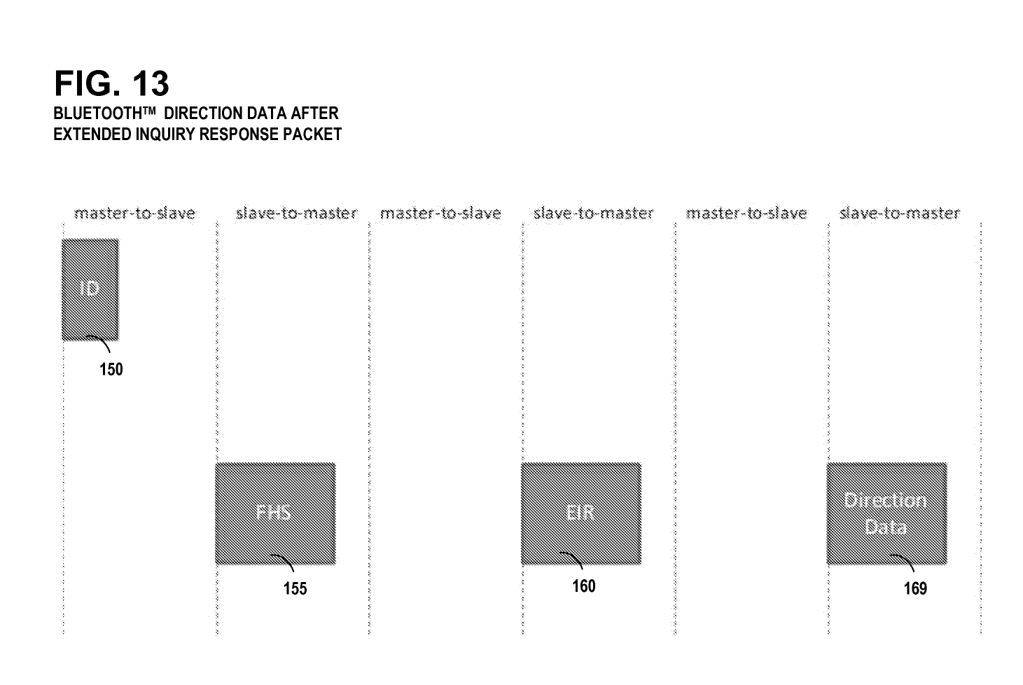

In embodiments of the invention, the direction estimation data 169 may be contained in a tail portion of the extended inquiry response packet 160, as shown in FIGS. 8A to 8C or in a payload field within the main portion of the extended inquiry response packet 160, as shown in FIG. 9, or in a separate packet to follow the extended inquiry response packet 160, as shown in FIGS. 12 and 13.

In embodiments of the invention, the four antennas A, B, C, and D of the antenna array 132 may be in a linear array or in an arbitrary array. An antenna array may be arranged one, two, or three dimensions. For a linear array, the four antennas A, B, C, and D are mounted on the inquiry scanning device 100 and arranged along a linear axis 182. A normal axis 180 is shown perpendicular to the linear axis 182. The two axes 180 and 182 define a plane within which the angle of departure (AoD) of the observation vector 184 lies, which will be the apparent direction of transmission of the reference data stream 200 from the inquiry scanning device 100, as seen from the inquiring device 102. The RF transmission emanating from each of the antennas A, B, C, and D is an isotropic electromagnetic wave. When the reference data stream 200 is transmitted by the antenna array 132 in sequential phases, the inquiring device 102 will have received the direction estimation data in the extended inquiry response packet 160. The direction estimating data includes data related to the characteristics of the antennas A, B, C, and D, the commutating frequency of the antennas, and other factors, the inquiring device 102 is able to estimate the angle of departure (AoD) as the apparent direction of transmission of the reference data stream from the inquiry scanning device 100, as seen from the inquiring device 102. The estimate the angle of departure (AoD) will enable a two-dimensional depiction of the direction of the inquiry scanning device 100 with respect to the inquiring device 102.

In embodiments of the invention, the four antennas A, B, C, and D of the antenna array 132 may be arranged in a two-dimensional array on the inquiry scanning device 100, in a plane that is perpendicular to the normal axis 180. In this arrangement, the angle of departure (AoD) and the observation vector 184 my lie outside of the plane formed by the linear axis 182 and the normal axis 180, enabling a three-dimensional depiction of the direction of the inquiry scanning device 100 with respect to the inquiring device 102.

FIG. 1C, for an example of angle of departure (AoD) estimation, discloses the example network diagram of FIGS. 1A and 1B, wherein during a first receiving interval, the inquiring device 102 receives the extended inquiry response packet 160. The inquiring device 102 includes an angle of departure (AoD) estimation program 140. In embodiments of the invention, if the received extended inquiry response packet 160 includes the “Direction Type” indication 166 of the existence of the information usable for estimating at least a relative direction 164, then the inquiring device 102 begins a second receiving interval of sampling and phase detecting the sequentially transmitted reference data stream 200 shown in FIGS. 2A and 2B, of the direction estimation data 169. The sampler and phase detector 176 performs a phase detection of the received 2-bit portions of the direction estimation data 169 in the reference data stream 200 and their mutual phase offsets 202′. Data related to the characteristics of the antennas A, B, C, and D, the commutating frequency of the antennas at the inquiry scanning device 100, and other factors, are included in the information usable for estimating at least a relative direction 164, which enable an estimate to be made by the sampler and phase detector 176 and decoder 178 of the angle of departure (AoD) of the reference data stream 200. Obtaining the estimated angle-of-departure (AoD) of the reference data stream with respect to the inquiry scanning device 100, enables the inquiring device 102 to present a depiction of the relative positions of the two devices on its display 174, in accordance with at least one embodiment of the present invention.

FIG. 1D, for an example of angle of departure (AoD) estimation, discloses an example timing diagram for an example exchange between the devices 100 and 102, of a special DIAC inquiry packet 150 transmitted from the inquiring device 102, and an inquiry response FHS packet 155 and an extended inquiry response packet 160 transmitted from the inquiry scanning device 100 in a first transmission interval in a normal Bluetooth™ transmission, the extended inquiry response packet 160 including the information usable for estimating at least a relative direction 164, and further shows an example timing of the reference data stream 200 in a second transmission interval from the inquiry scanning device 100 where antenna elements of the antenna array 132 are sequentially switched antennas during transmitting the direction estimation data 169.

In an example alternate embodiment of the invention, the Bluetooth™ FHS packet 155 includes the “Direction Type” indication 166 that the information usable for estimating at least a relative direction 164 exists in a subsequent packet.

FIG. 1E, for an example of angle of departure (AoD) estimation, discloses an example of how the bits in the direction estimation data 169 from the extended inquiry response packet 160 are transmitted in a continuous wave or sequence by the antenna array 132 at the inquiry scanning device 100 and sampled at the inquiring device 102, in accordance with at least one embodiment of the present invention.

FIG. 1F, for an example of angle of departure (AoD) estimation, discloses the example network diagram of FIG. 1A, in an alternate embodiment wherein the inquiry scanning device 100 responds to receiving the predetermined dedicated inquiry (DIAC) packet 150 by a simplified procedure of including part or all of the FHS data 163 in the extended inquiry response packet 160, along with the information usable for estimating at least a relative direction 164 that it transmits, thereby rendering unnecessary the transmission of a separate FHS packet, in accordance with at least one embodiment of the present invention.

FIG. 1G, for an example of angle of departure (AoD) estimation, discloses an example timing diagram for the alternate embodiment of FIG. 1F, of a predetermined dedicated inquiry (DIAC) packet 150 transmitted from the inquiring device 102 and a simplified procedure of an extended inquiry response packet 160 transmitted from the inquiry scanning device 100 that includes FHS data 163, thereby rendering unnecessary the transmission of a separate FHS packet, in accordance with at least one embodiment of the present invention.

FIG. 2A, for an example of angle of departure (AoD) estimation, discloses an example network diagram illustrating a relative location along the normal axis 180 perpendicular to the antenna array 132 of the inquiry scanning device 100, the axis 180 intersecting the inquiring device 102. In the arrangement of the devices 100 and 102 in FIG. 2A, the angle of departure (AoD) is zero degrees. FIG. 2A shows the resulting relationship of the phases 202′ for the 2-bit portions of the direction estimation data 169 in the reference data stream 200 as they are received in the second receiving interval, at the inquiring device 102, when compared with the phases 202 for the 2-bit portions of the direction estimation data 169 as they were sequentially transmitted in the second transmitting interval by the four antennas A, B, C, and D at the inquiry scanning device 100, in accordance with at least one embodiment of the present invention. In the example of FIG. 2A, the relationship determined by the sampler and phase detector 176 and decoder 178 between the phases 202′ for the 2-bit portions of the direction estimation data 169 in the reference data stream 200 as they are received at the inquiring device 102, is substantially the same as the relationship between the phases 202 for the 2-bit portions of the direction estimation data 169 as they were sequentially transmitted by the four antennas A, B, C, and D at the inquiry scanning device 100. Based on this determination by the sampler and phase detector 176 and decoder 178, the estimated angle of departure (AoD) is zero degrees.

FIG. 2B, for an example of angle of departure (AoD) estimation, discloses an example network diagram illustrating a second relative location along a second axis 184 offset from the normal axis 180, of the inquiry scanning device 100 and the inquiring device 102. In the arrangement of the devices 100 and 102 in FIG. 2B, the angle of departure (AoD) is, for example, thirty degrees. FIG. 2B shows the resulting relationship of the phases 202′ for the 2-bit portions of the direction estimation data 169 in the reference data stream 200 as they are received in the second receiving interval, at the inquiring device 102, when compared with the phases 202 for the 2-bit portions of the direction estimation data 169 as they were sequentially transmitted in the second transmitting interval by the four antennas A, B, C, and D at the inquiry scanning device 100, in accordance with at least one embodiment of the present invention. In the example embodiment of FIG. 2A, the relationship determined by the sampler and phase detector 176 and decoder 178 between the phases 202′ for the 2-bit portions of the direction estimation data 169 in the reference data stream 200 as they are received at the inquiring device 102, shows that their phases are shifted in time of arrival with respect to the relationship between the phases 202 for the 2-bit portions of the direction estimation data 169 as they were sequentially transmitted by the four antennas A, B, C, and D at the inquiry scanning device 100. The phase shift, in this example embodiment, is due to the change in the propagation distance between the individual elements of the antenna array 132 at the inquiry scanning device 100 and the antenna 170 at the inquiring device 102. In the example embodiment of FIG. 2B, the relationship determined by the sampler and phase detector 176 and decoder 178 between the phases 202′ at the inquiring device 102 and the phases 202 at the inquiry scanning device 100, results in an estimated angle of departure (AoD) of thirty degrees. Obtaining the estimated angle-of-departure (AoD) of the reference data stream with respect to the inquiry scanning device 100, enables the inquiring device 102 to present a depiction of the relative positions of the two devices on its display 174, in accordance with at least one embodiment of the present invention.

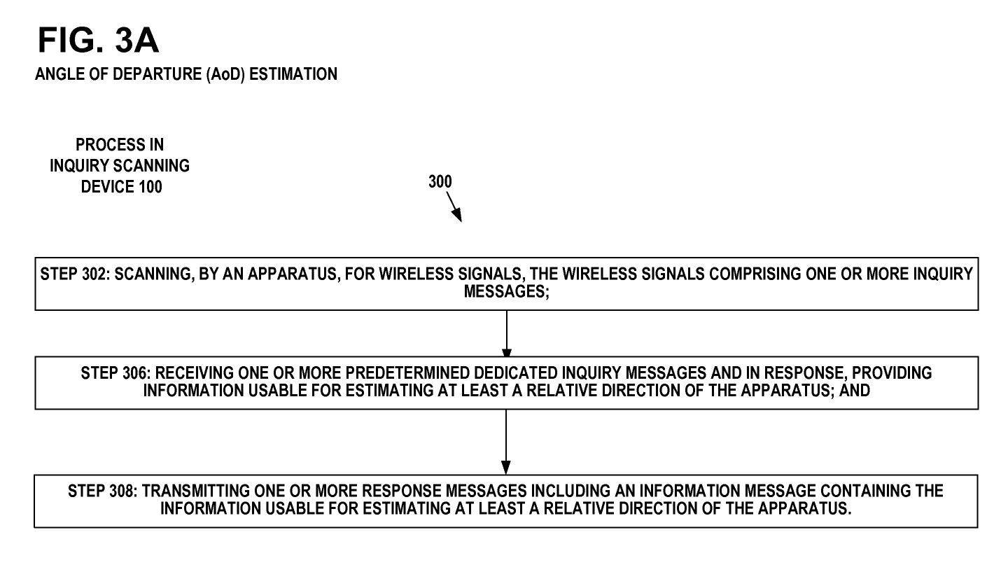

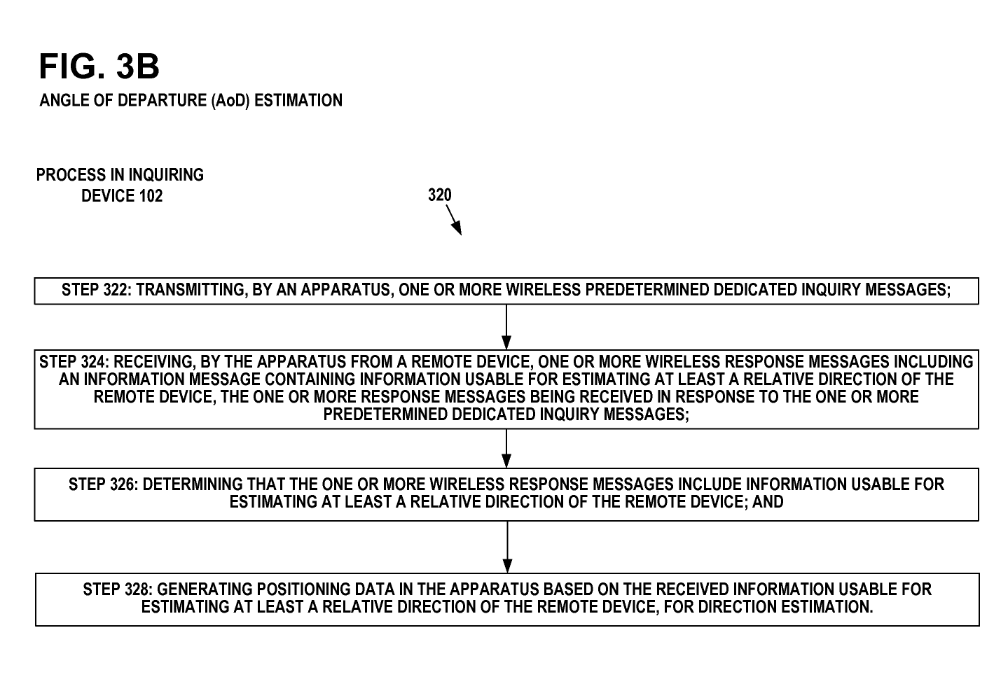

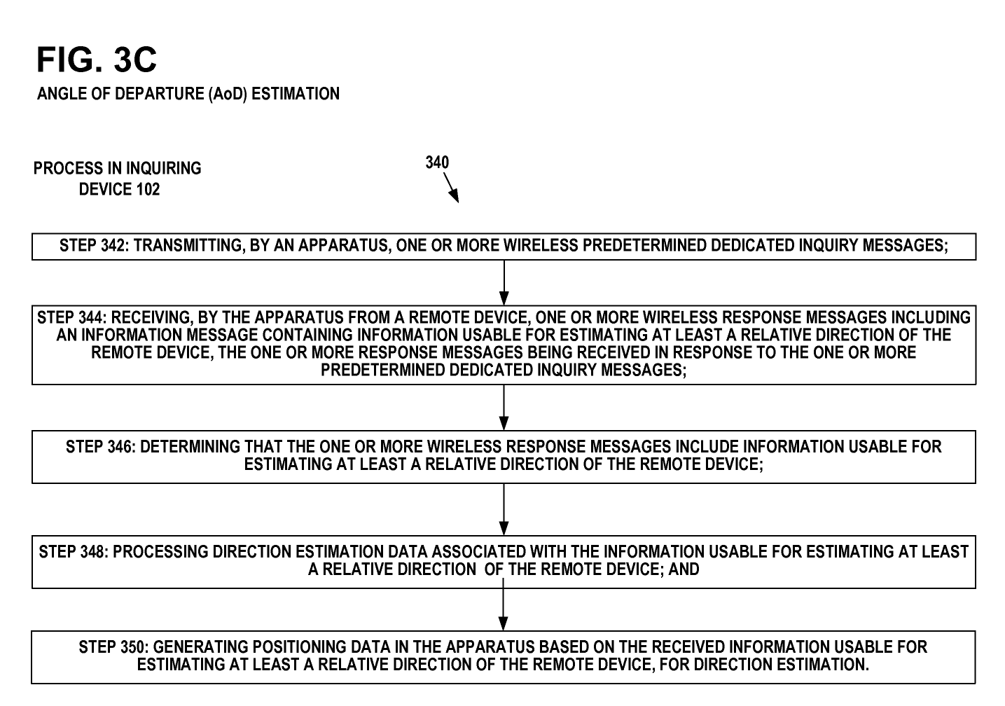

FIG. 3A, for an example of angle of departure (AoD) estimation, is an example embodiment of a flow diagram 300 of a method, from the point of view of the inquiry scanning device 100, according to at least one embodiment. The steps of the flow diagram represent computer code instructions stored in the RAM and/or ROM memory of the inquiry scanning device 100, which when executed by the central processing units (CPU) 124 and/or 125, carry out the functions of the example embodiments of the invention. The steps may be carried out in another order than shown and individual steps may be combined or separated into component steps. The flow diagram has the following steps:

Step 302: scanning, by an apparatus, for wireless signals, the wireless signals comprising one or more inquiry messages;

Step 306: receiving one or more predetermined dedicated inquiry messages and in response, providing information usable for estimating at least a relative direction of the apparatus; and

Step 308: transmitting one or more response messages including an information message containing the information usable for estimating at least a relative direction of the apparatus.

FIG. 3B, for an example of angle of departure (AoD) estimation, is an example embodiment of a flow diagram 320 of a method, from the point of view of the inquiring device 102, according to at least one embodiment. The steps of the flow diagram represent computer code instructions stored in the RAM and/or ROM memory of the inquiring device 102, which when executed by the central processing units (CPU) 124 and/or 125, carry out the functions of the example embodiments of the invention. The steps may be carried out in another order than shown and individual steps may be combined or separated into component steps. The flow diagram has the following steps:

Step 322: transmitting, by an apparatus, one or more wireless predetermined dedicated inquiry messages;

Step 324: receiving, by the apparatus from a remote device, one or more wireless response messages including an information message containing information usable for estimating at least a relative direction of the remote device, the one or more response messages being received in response to the one or more predetermined dedicated inquiry messages;

Step 326: determining that the one or more wireless response messages include information usable for estimating at least a relative direction of the remote device; and

Step 328: generating positioning data in the apparatus based on the received information usable for estimating at least a relative direction of the remote device, for direction estimation.

FIG. 3C, for an example alternate of angle of departure (AoD) estimation, is an example embodiment of a flow diagram 340 of a method, from the point of view of the inquiring device 102, according to at least one embodiment. The steps of the flow diagram represent computer code instructions stored in the RAM and/or ROM memory of the inquiring device 102, which when executed by the central processing units (CPU) 124 and/or 125, carry out the functions of the example embodiments of the invention. The steps may be carried out in another order than shown and individual steps may be combined or separated into component steps. The flow diagram has the following steps:

Step 342: transmitting, by an apparatus, one or more wireless predetermined dedicated inquiry messages;

Step 344: receiving, by the apparatus from a remote device, one or more wireless response messages including an information message containing information usable for estimating at least a relative direction of the remote device, the one or more response messages being received in response to the one or more predetermined dedicated inquiry messages;

Step 346: determining that the one or more wireless response messages include information usable for estimating at least a relative direction of the remote device;

Step 348: processing direction estimation data associated with the information usable for estimating at least a relative direction of the remote device; and

Step 350: generating positioning data in the apparatus based on the received information usable for estimating at least a relative direction of the remote device, for direction estimation.

### 2. EXAMPLES OF ANGLE OF ARRIVAL (AoA) ESTIMATION

The term “angle of arrival (AoA)”, as used herein, is employed with reference to an array of antennas arranged with a normal axis. A normal axis perpendicular to a linear axis defines a plane with the linear antenna array. The apparent direction of reception of a signal by the linear antenna array, as seen from a remote transmitting device occupying the plane, may be represented by an observation vector. The angle between the observation vector and the normal axis is defined as the angle of arrival (AoA) of the signal as it approaches the antenna array. In embodiments, the antenna array may be arranged in a two-dimensional array in a plane and the normal axis is perpendicular to the plane of the antenna array. In this arrangement, the angle of arrival (AoA) is similarly defined as the angle between the observation vector and the normal axis to the plane. In embodiments, the antenna array may be arranged in any arbitrary manner, either in a linear array, a two-dimensional array, or a three dimensional array.

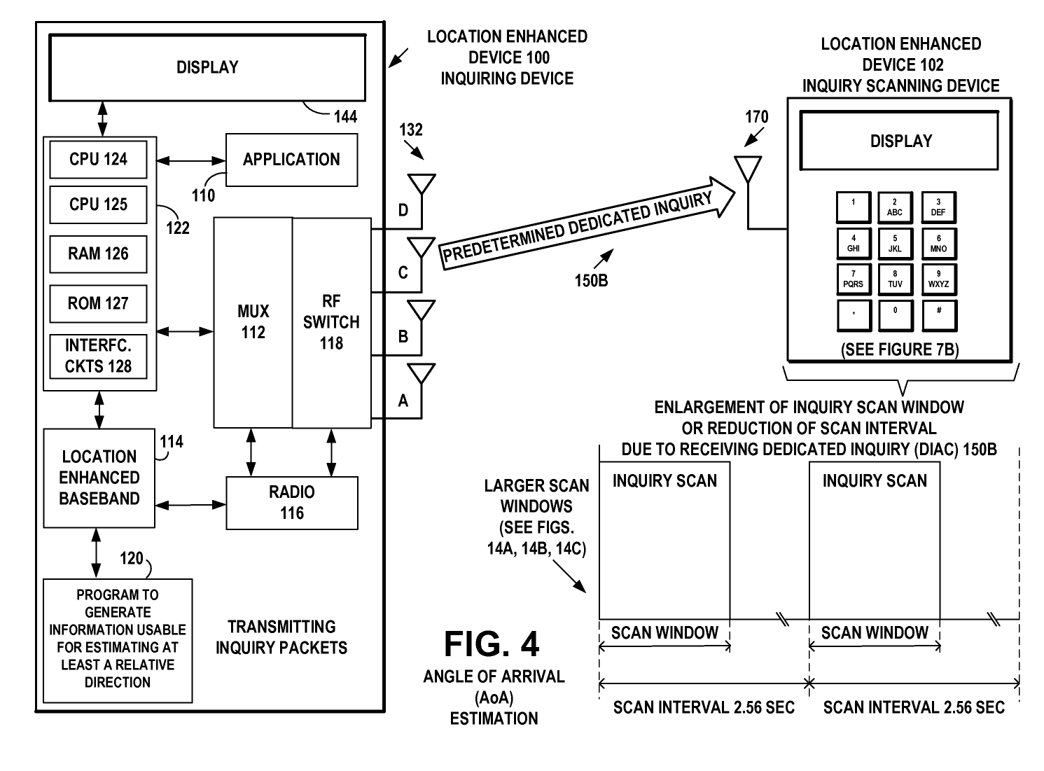

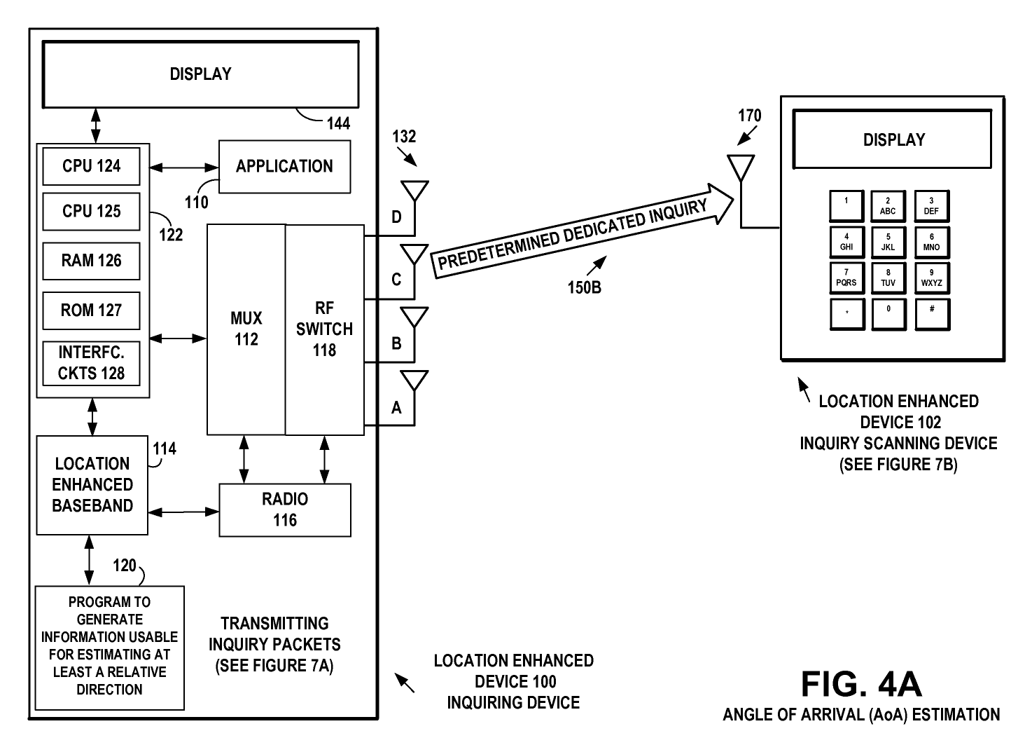

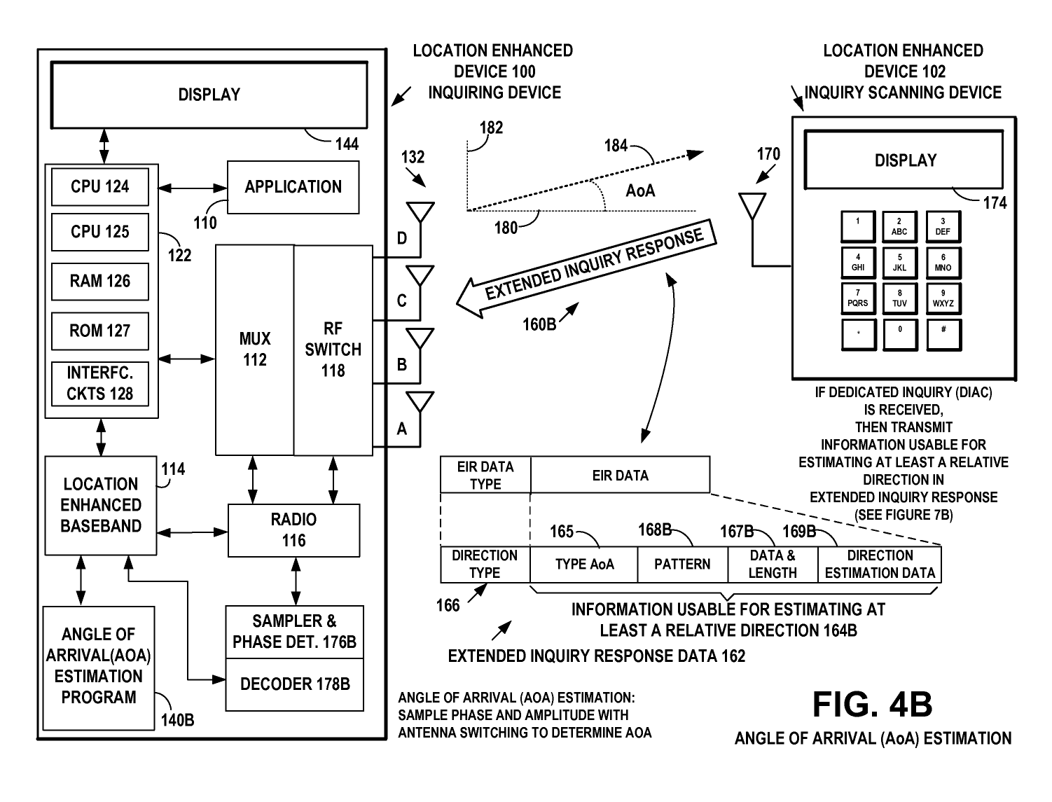

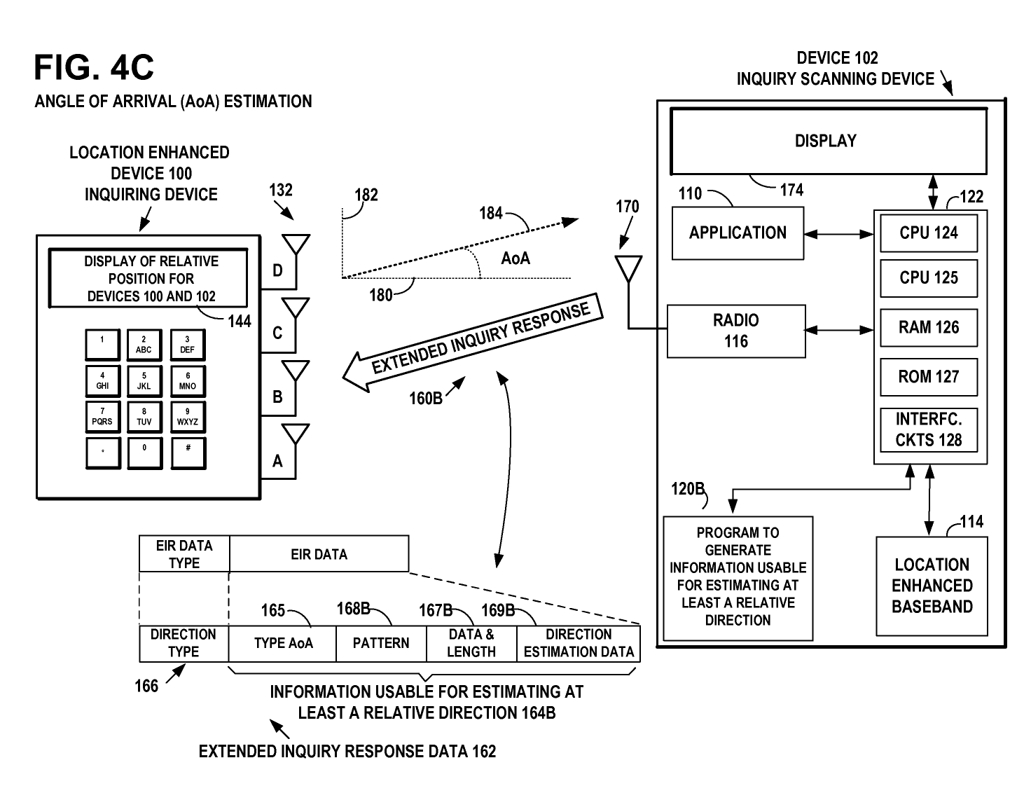

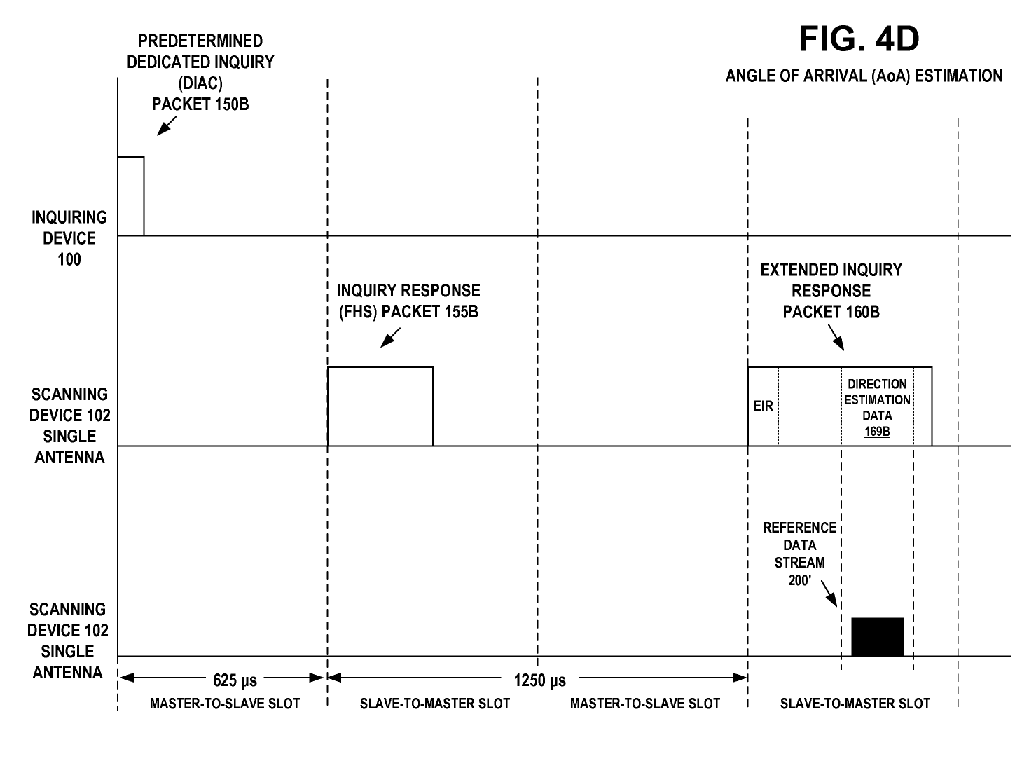

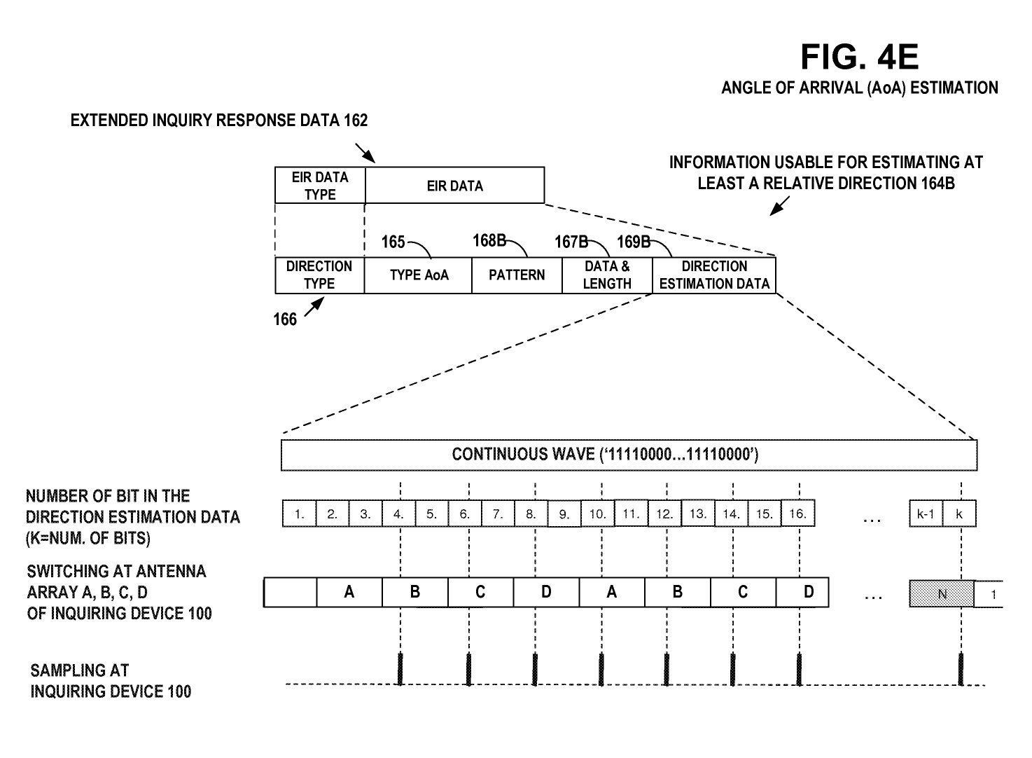

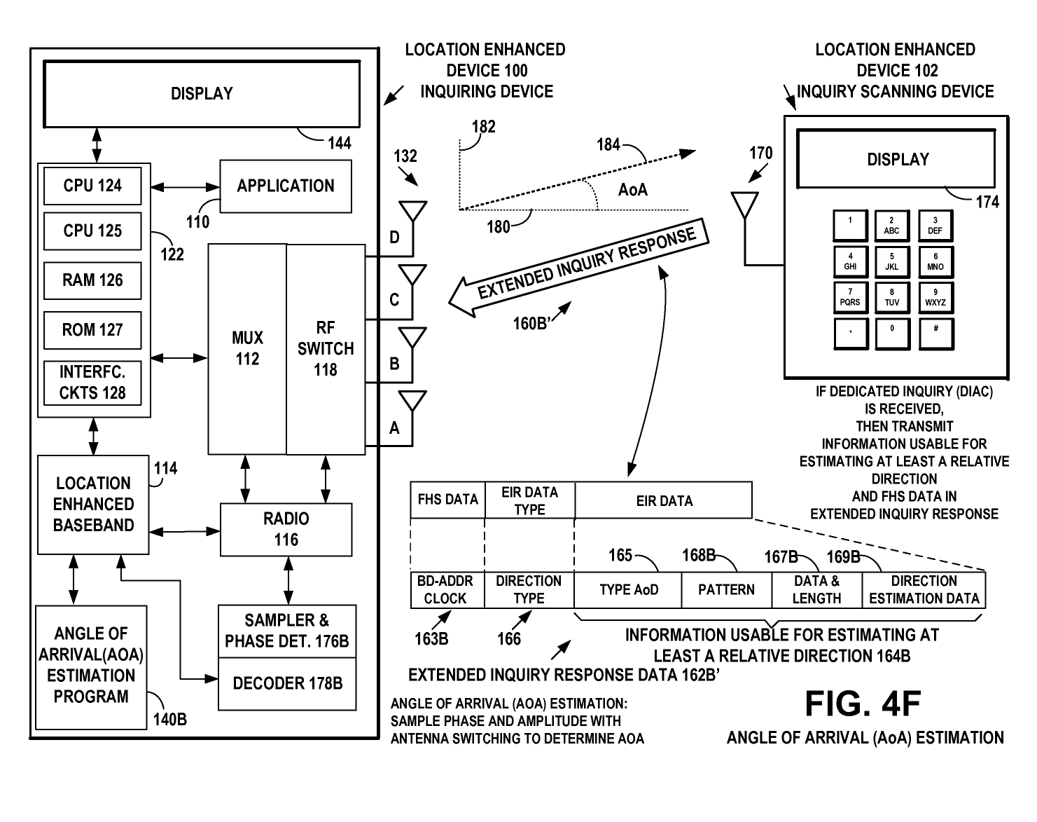

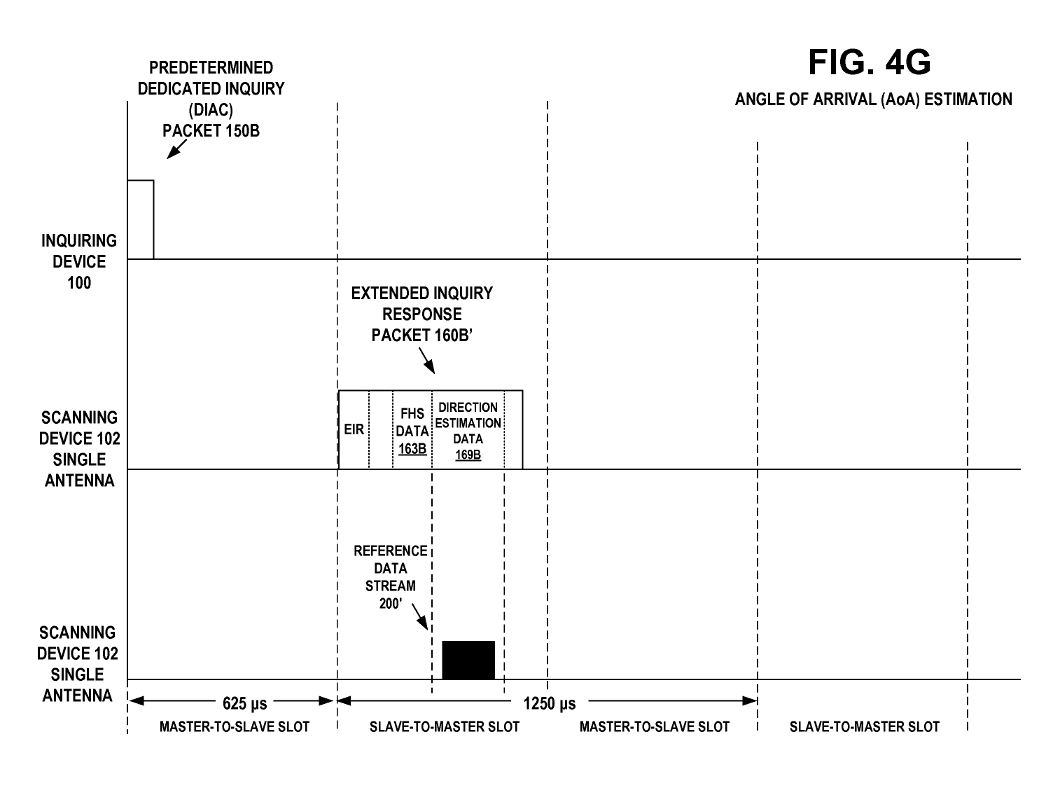

FIG. 4, for an example of angle of arrival (AoA) estimation, discloses a location enhanced Bluetooth™ device 102 in inquiry scanning mode, receiving a predetermined dedicated inquiry (DIAC) packet 150B from another Bluetooth™ device 100 in inquiry mode, and in response, modifying its device detection procedure to improve detection of inquiry signals, by either enlarging the inquiry scan window or reducing the interval between scans, in accordance with at least one embodiment of the present invention. See FIG. 14B for a more detailed depiction of the operation of increasing the duration of the scan window. Alternately, during the inquiry scan state of an inquiry scanning device, after receiving a predetermined dedicated inquiry (DIAC) 150B, the scanning device modifies the Bluetooth™ inquiry scanning procedures for receiving inquiry signals, by decreasing the duration of the scan interval between scans in response to the receipt of the predetermined dedicated inquiry (DIAC) packet 150B, as shown in the flow diagram of FIG. 7B, step 742. See FIG. 14C for a more detailed depiction of the operation of decreasing the duration of the scan interval between scans.

FIG. 4A, for an example of angle of arrival (AoA) estimation, discloses an example network diagram illustrating a location enhanced Bluetooth™ device 102 in inquiry scanning mode receiving an inquiry packet 150B from a location enhanced Bluetooth™ device 100 that is a direction finding capable device in inquiry mode, in accordance with at least one embodiment of the present invention.

The inquiry packet 150B broadcast by the inquiring device signifies that the inquiring device, by virtue of transmitting the special DIAC, is capable of receiving and using information usable for estimating at least a relative direction, as described herein. The inquiry scanning device, will recognize the special DIAC 150B and, in response, generate and transmit information usable for estimating at least a relative direction. See FIG. 7B of an example flow diagram of an example method, from the point of view of the inquiry scanning device receiving a predetermined dedicated inquiry (DIAC) packet 150B, in accordance with at least one embodiment of the present invention.

FIG. 4B, for an example of angle of arrival (AoA) estimation, discloses the example network diagram of FIG. 4A, of the inquiry scanning device 102 responding to the special DIAC inquiry packet 150B by providing information usable for estimating at least a relative direction 164B. In embodiments of the invention, in a first transmission interval, the inquiry scanning device 102 transmits the extended inquiry response packet 160B with the information usable for estimating at least a relative direction 164B, in a normal Bluetooth™ transmission. The extended inquiry response data 162 in the extended inquiry response packet 160 includes an indication 166, “Direction Type” that is used to inform the receiving, inquiring device 100 about the existence and properties of the information usable for estimating at least a relative direction 164B.

In FIG. 4B, inquiry scanning device 102 has a single antenna 170 for transmitting the information usable for estimating at least a relative direction 164 in the in the extended inquiry response packet 160B and the inquiring device 100 may have a linear antenna array or an arbitrary array 132 for receiving the information usable for estimating at least a relative direction 164. An antenna array may be arranged one, two, or three dimensions. The receiving, inquiring device 100 will estimate the angle of arrival (AoA) with respect to itself, in accordance with example embodiments of the invention.

The information usable for estimating at least a relative direction 164B may include an indication whether the positioning information relates to angle-of-arrival (AoA) positioning information, angle-of-departure (AoD) positioning information, or both types. The information usable for estimating at least a relative direction 164B may include a reference binary bit pattern 168B, such as “11110000”. The information usable for estimating at least a relative direction 164B may include a data and length field 167B, that includes data such as coding, length of the direction estimation data, and other factors useful in enabling the inquiring device 102 to estimate a direction. The information usable for estimating at least a relative direction 164B may also include direction estimation data 169B that may comprise of several concatenated segments of the binary bit pattern 168. In embodiments of the invention, in the first transmission interval, the inquiry scanning device 102 transmits the extended inquiry response packet 160B in a normal Bluetooth™ transmission from the antenna 170. The direction estimation data 169B is transmitted as a reference data stream 200′.

The inquiring device 100 receives the extended inquiry response packet 160B with the information usable for estimating at least a relative direction 164. The reference data stream 200′ transmission from the inquiry scanning device 102 is received by the antenna array 132 at the inquiring device 100, the antenna array sequentially switching the data stream 200′ during reception. The angle of arrival (AoA) estimation is made by sampling the phase and amplitude of the reference bits of the direction estimation data 169. The information usable for estimating at least a relative direction 164B may include a data and length field 167B, that includes data such as coding, length of the direction estimation data, and other factors useful in enabling the inquiring device 102 to estimate a direction. The information usable for estimating at least a relative direction 164B may also include direction estimation data 169 that may comprise of several concatenated segments of the binary bit pattern 168. In embodiments of the invention, in the first transmission interval, the inquiry scanning device 102 transmits the extended inquiry response packet 160B in a normal Bluetooth™ transmission from the antenna 170. The direction estimation data 169 is transmitted as a reference data stream 200′.

The inquiring device 100 receives the extended inquiry response packet 160B with the information usable for estimating at least a relative direction 164. The reference data stream 200′ transmission from the inquiry scanning device 102 is received by the antenna array 132 at the inquiring device 100, the antenna array sequentially switching the data stream 200′ during reception. The angle of arrival (AoA) estimation is made by sampling the phase and amplitude of the reference bits of the direction estimation data 169B in the data stream 200′ with the antenna switching. The inquiring device 102 includes a sampler and phase detector 176B, a decoder 178B, and an angle of arrival (AoA) estimation program 140B to estimate the angle of arrival (AoA) of the reference data stream 200′, based on the information usable for estimating at least a relative direction 164B received from the inquiry scanning device 102.

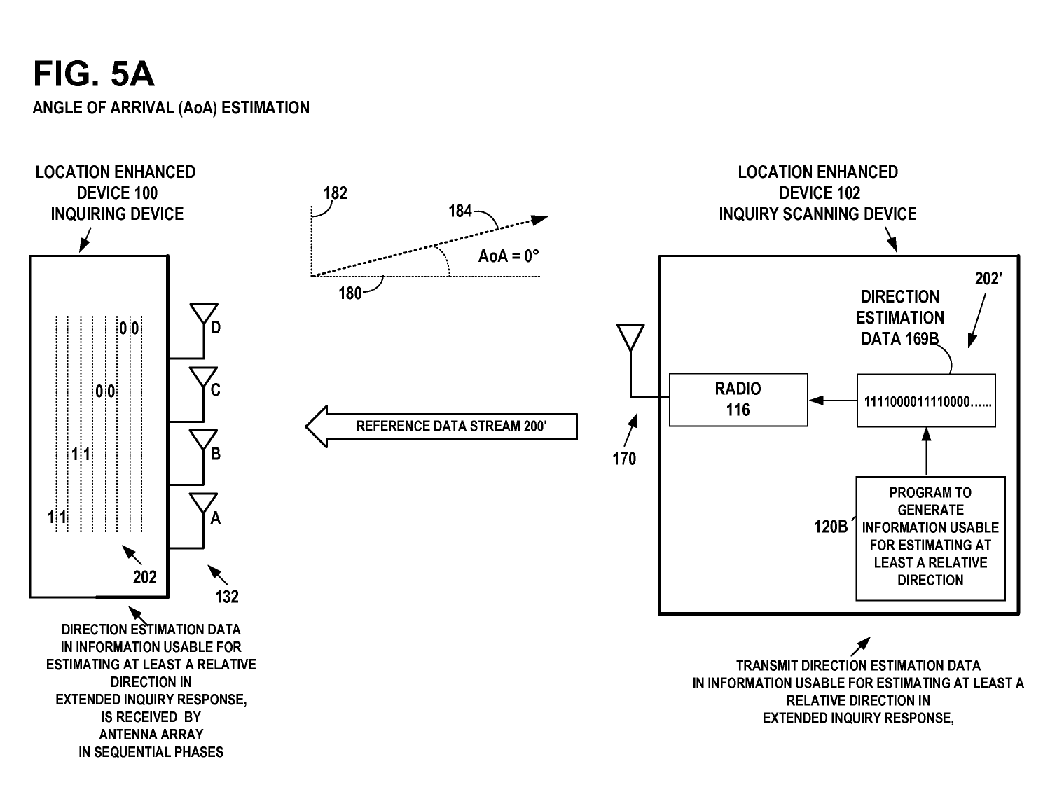

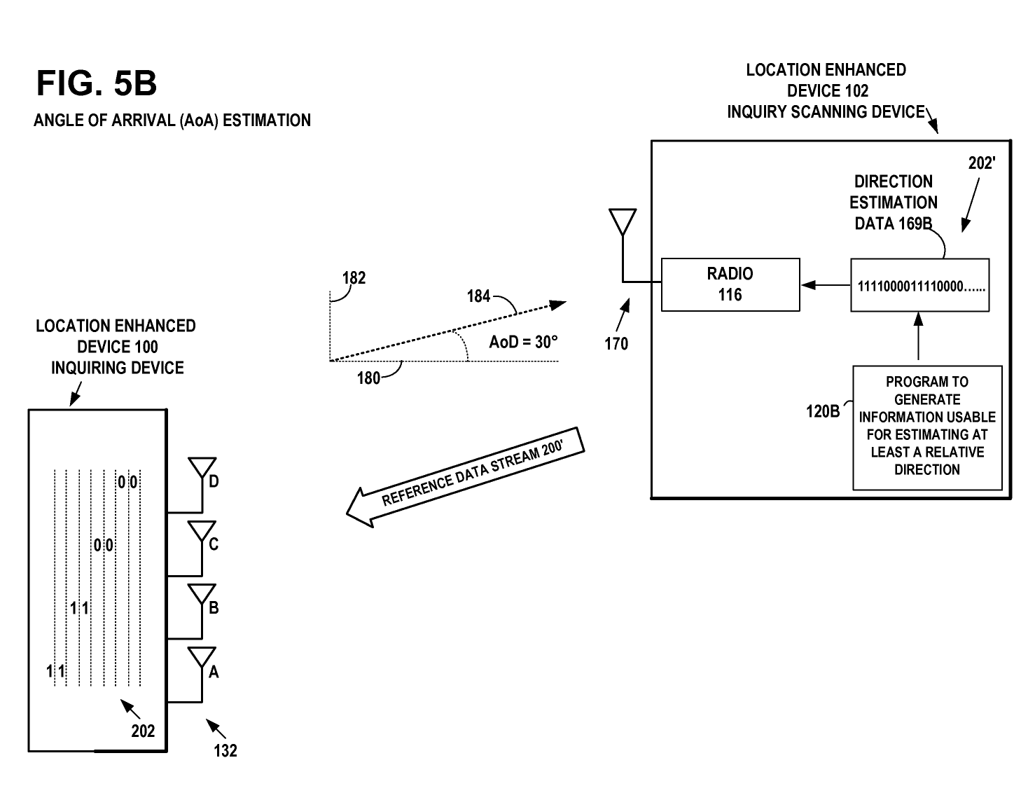

FIG. 4C, for an example of angle of arrival (AoA) estimation, discloses the example network diagram of FIGS. 4A and 4B, of the inquiring device 100 receiving during a first receiving interval, the extended inquiry response packet 160B including the information usable for estimating at least a relative direction 164B and determining that the extended inquiry response packet 160B includes information usable for estimating at least a relative direction 164B, in accordance with at least one embodiment of the present invention. In embodiments of the invention, if the received extended inquiry response packet 160B includes the “Direction Type” indication 166 of the existence of the information usable for estimating at least a relative direction 164B, then the inquiring device 100 begins a second receiving interval of sampling and phase detecting the sequentially transmitted reference data stream 200′ shown in FIGS. 5A and 5B, of the direction estimation data 169B. The sampler and phase detector 176B performs a phase detection of received 2-bit portions of the direction estimation data 169B in the reference data stream 200′ and their mutual phase offsets 202. Data related to the characteristics of the antennas A, B, C, and D, the commutating frequency of the antennas at the inquiring device 100, and other factors, are characteristics known to the inquiring device 100, which enable an estimate to be made by the sampler and phase detector 176B and decoder 178B of the angle of arrival (AoA) of the reference data stream 200′. Obtaining the estimated angle-of-arrival (AoA) of the reference data stream with respect to the inquiring device 100, enables the inquiring device 100 to present a depiction of the relative positions of the two devices on its display 144, in accordance with at least one embodiment of the present invention.

FIG. 4D, for an example of angle of arrival (AoA) estimation, discloses an example timing diagram for an example exchange between the devices 100 and 102, of a special DIAC inquiry packet 150B transmitted from the inquiring device 100, and an inquiry response (FHS) packet 155B and an extended inquiry response packet 160B transmitted from the inquiry scanning device 102 in a normal Bluetooth™ transmission, the extended inquiry response packet 160B including the information usable for estimating at least a relative direction 164B, the figure further showing an example timing of the reference data stream 200′ transmission from the inquiry scanning device 102, which is received by the antenna array 132 at the inquiring device 100, the antenna array 132 sequentially switching the data stream 200′ during reception.

In an example alternate embodiment of the invention, the FHS packet 155B includes the “Direction Type” indication 166 that the information usable for estimating at least a relative direction 164B exists in a subsequent packet.

FIG. 4E, for an example of angle of arrival (AoA) estimation, discloses an example of how the bits in the direction estimation data 169B from the extended inquiry response packet 160B are transmitted by the single antenna 170 at the inquiry scanning device 102 and received by the antenna array 132 and sampled at the inquiring device 100, in accordance with at least one embodiment of the present invention.

FIG. 4F, for an example of angle of arrival (AoA) estimation, discloses the example network diagram of FIG. 1A, in an alternate embodiment wherein the inquiry scanning device 102 responds to receiving the predetermined dedicated inquiry (DIAC) packet 150B by a simplified procedure of including part or all of the FHS data 163B in the extended inquiry response packet 160B′, along with the information usable for estimating at least a relative direction 164B that it transmits, thereby rendering unnecessary the transmission of a separate FHS packet, in accordance with at least one embodiment of the present invention.

FIG. 4G, for an example of angle of arrival (AoA) estimation, discloses an example timing diagram for the alternate embodiment of FIG. 4F, of a predetermined dedicated inquiry (DIAC) packet 150B transmitted from the inquiring device 100 and a simplified procedure of an extended inquiry response packet 160B′ transmitted from the inquiry scanning device 102 that includes FHS data 163B, thereby rendering unnecessary the transmission of a separate FHS packet, in accordance with at least one embodiment of the present invention.

FIG. 5A, for an example of angle of arrival (AoA) estimation, discloses an example network diagram illustrating a relative location along a first axis 180 of the inquiry scanning device 102 and the inquiring device 100. In embodiments of the invention, the inquiry scanning device 102 transmits the reference data stream 200′ based on the information usable for estimating at least a relative direction 164B. The reference data stream 200′ of bits in the direction estimation data 169B transmitted from the inquiry scanning device 102 is received by the antenna array 132 at the inquiring device 100, the antenna array 132 sequentially switching the data stream 200′ during reception. The inquiring device 100 receives the reference data stream 200′ and decodes the reference data stream 200′ to obtain a direction value, based on the extended inquiry response packet 160B with the information usable for estimating at least a relative direction 164B, in accordance with at least one embodiment of the present invention.

FIG. 5B, for an example of angle of arrival (AoA) estimation, discloses an example network diagram illustrating a second relative location along a second axis 184 offset from the first axis 180, of the inquiry scanning device 102 and the inquiring device 100. In embodiments of the invention, the inquiry scanning device 102 transmits the reference data stream 200′ of bits in the direction estimation data 169B based on the information usable for estimating at least a relative direction 164B. The reference data stream 200′ transmitted from the inquiry scanning device 102 is received by the antenna array 132 at the inquiring device 100, the antenna array 132 sequentially switching the data stream 200′ during their reception. The inquiring device 100 receives the reference data stream 200′ and decodes the reference data stream 200′ to obtain a direction value, based on the extended inquiry response packet 160B with the information usable for estimating at least a relative direction 164B, in accordance with at least one embodiment of the present invention.

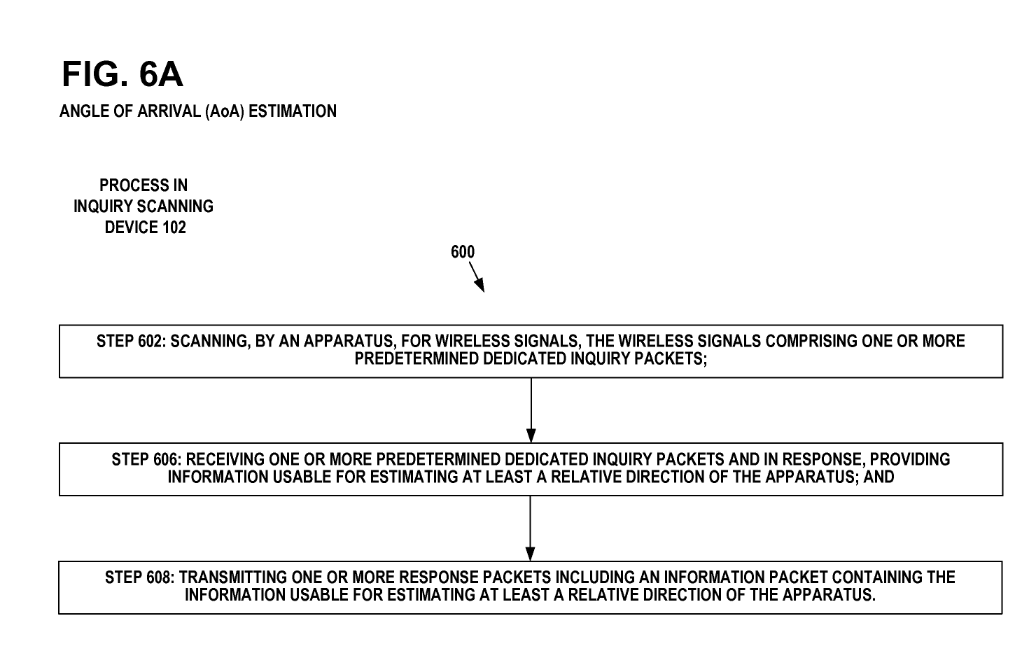

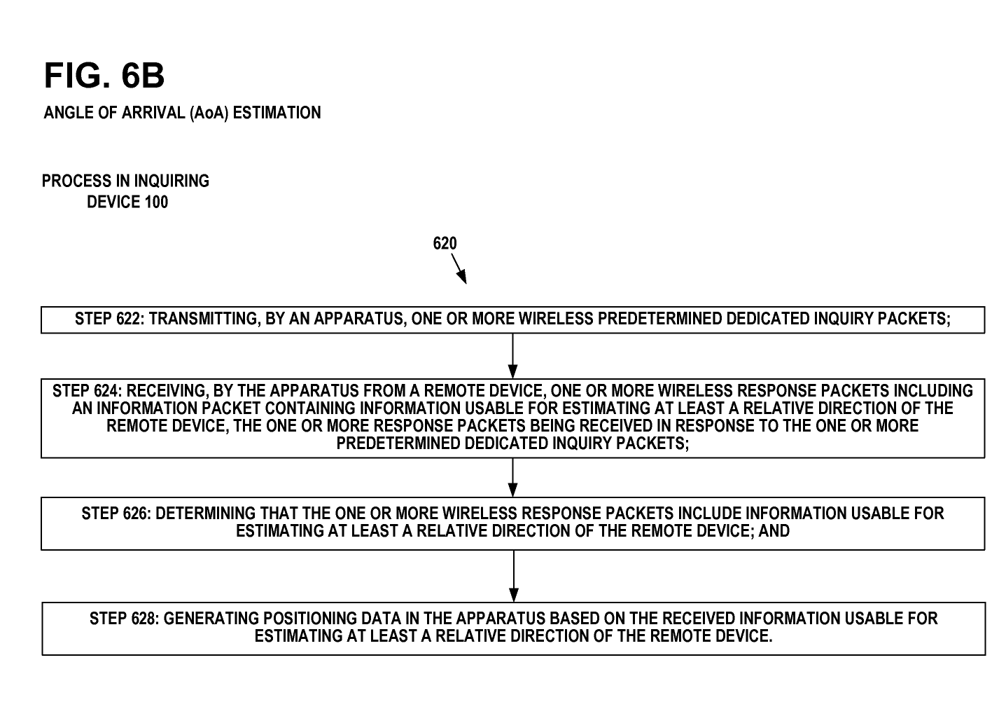

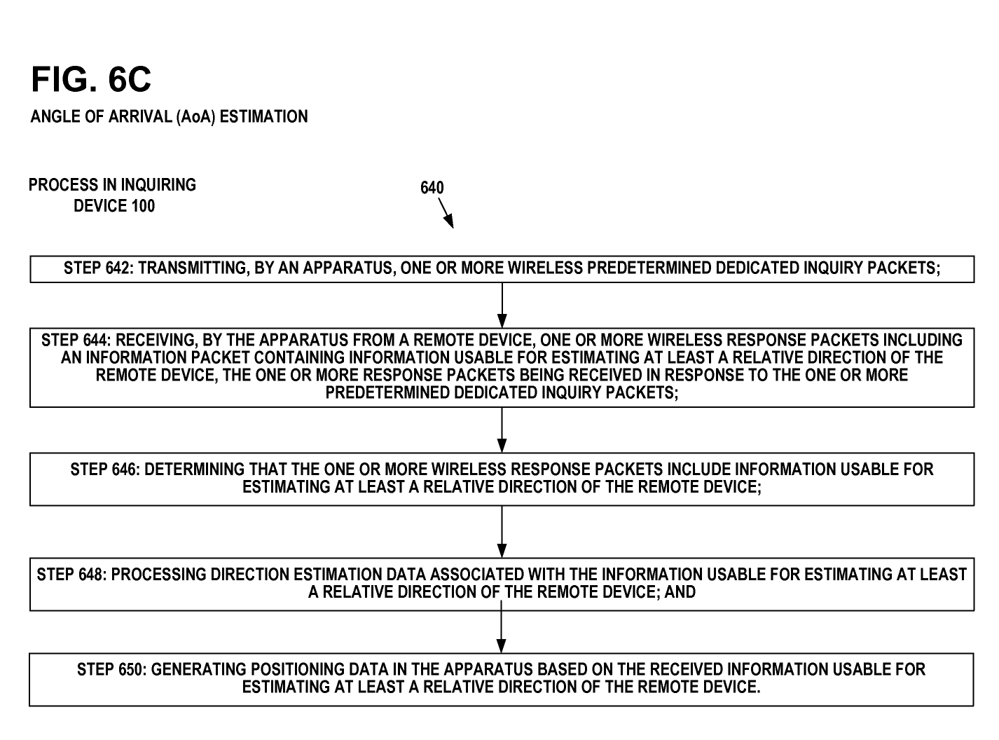

FIG. 6A, for an example of angle of arrival (AoA) estimation, is an example embodiment of a flow diagram 600 of an example method, from the point of view of the inquiry scanning device 102, in accordance with at least one embodiment of the present invention. The steps of the flow diagram represent computer code instructions stored in the RAM and/or ROM memory of the inquiry scanning device 102, which when executed by the central processing units (CPU) 124 and/or 125, carry out the functions of the example embodiments of the invention. The steps may be carried out in another order than shown and individual steps may be combined or separated into component steps. The flow diagram has the following steps:

Step 602: scanning, by an apparatus, for wireless signals, the wireless signals comprising one or more predetermined dedicated inquiry packets;

Step 606: receiving one or more predetermined dedicated inquiry packets and in response, providing information usable for estimating at least a relative direction of the apparatus; and

Step 608: transmitting one or more response packets including an information packet containing the information usable for estimating at least a relative direction of the apparatus.

FIG. 6B, for an example of angle of arrival (AoA) estimation, is an example embodiment of a flow diagram 620 of an example method, from the point of view of the inquiring device 100, in accordance with at least one embodiment of the present invention. The steps of the flow diagram represent computer code instructions stored in the RAM and/or ROM memory of the inquiring device 100, which when executed by the central processing units (CPU) 124 and/or 125, carry out the functions of the example embodiments of the invention. The steps may be carried out in another order than shown and individual steps may be combined or separated into component steps. The flow diagram has the following steps:

Step 622: transmitting, by an apparatus, one or more wireless predetermined dedicated inquiry packets;

Step 624: receiving, by the apparatus from a remote device, one or more wireless response packets including an information packet containing information usable for estimating at least a relative direction of the remote device, the one or more response packets being received in response to the one or more predetermined dedicated inquiry packets;

Step 626: determining that the one or more wireless response packets include information usable for estimating at least a relative direction of the remote device; and

Step 628: generating positioning data in the apparatus based on the received information usable for estimating at least a relative direction of the remote device.

FIG. 6C, for an example of angle of arrival (AoA) estimation, is an example alternate embodiment of a flow diagram 640 of an example method, from the point of view of the inquiring device 100, in accordance with at least one embodiment of the present invention. The steps of the flow diagram represent computer code instructions stored in the RAM and/or ROM memory of the inquiring device 100, which when executed by the central processing units (CPU) 124 and/or 125, carry out the functions of the example embodiments of the invention. The steps may be carried out in another order than shown and individual steps may be combined or separated into component steps. The flow diagram has the following steps:

Step 642: transmitting, by an apparatus, one or more wireless predetermined dedicated inquiry packets;

Step 644: receiving, by the apparatus from a remote device, one or more wireless response packets including an information packet containing information usable for estimating at least a relative direction of the remote device, the one or more response packets being received in response to the one or more predetermined dedicated inquiry packets;

Step 646: determining that the one or more wireless response packets include information usable for estimating at least a relative direction of the remote device;

Step 648: processing direction estimation data associated with the information usable for estimating at least a relative direction of the remote device; and

Step 650: generating positioning data in the apparatus based on the received information usable for estimating at least a relative direction of the remote device.

### E. EXAMPLES OF PROCESSING THE PREDETERMINED DEDICATED INQUIRY (DIAC) PACKET

FIG. 7A is an example flow diagram of an example method, from the point of view of the inquiring device transmitting a predetermined dedicated inquiry (DIAC) packet, in accordance with at least one embodiment of the present invention. The example method is from the point of view of the inquiring device. The method starts at the idle step 702. In a typical scenario, the inquiring device first tries in step 704, to find all discoverable devices within range by transmitting the GIAC inquiry packet. In step 706 some devices are discovered that have responded with an inquiry response packet that indicates the responding device is a direction finding capable device. Then, in step 708, the inquiring device transmits the special inquiry DIAC 150. In response, the responding device transmits, and the inquiring device receives an extended inquiry response packet 160 that includes the information usable for estimating at least a relative direction 164. In step 710, the inquiring device determines that the extended inquiry response 160 includes information usable for estimating at least a relative direction. The inquiring device reads direction estimating data associated with the information usable for estimating at least a relative direction. The inquiring device generates positioning data from the direction estimating data to track the location of the responding device. The inquiring device enters a loop with steps 708 and 710 to continuously track the responding device. In alternate embodiments where the inquiring device only wants to track devices that have direction finding capability, the inquiring device may omit transmitting GIAC inquiry packets in step 704.

FIG. 7B is an example flow diagram of an example method, from the point of view of the inquiry scanning device receiving a predetermined dedicated inquiry (DIAC) packet 150, in accordance with at least one embodiment of the present invention. The inquiry scanning device in this example, is a direction finding capable device, in accordance with embodiments of the invention. The example method is from the point of view of the inquiry scanning device perspective. In the idle state of step 732 the inquiry scanning device is discoverable. In steps 734 and 736, if the received inquiry packet is a GIAC inquiry (or a LIAC inquiry in some cases), then the inquiry scanning device responds in the normal fashion with an FHS packet and, optionally, a following extended inquiry response packet. The scanning device may perform special DIAC inquiry scanning simultaneously with GIAC/LIAC inquiry scanning. In step 738, when a special DIAC packet 150 is received, the inquiry scanning device responds by providing information usable for estimating at least a relative direction 164 and direction estimating data 169 and in step 740 transmitting that information in an extended inquiry response packet 160. When the inquiry scanning device receives the first special DIAC, a response packet is sent and the scanning interval for scanning special DIACs may be changed to a more frequent or continuous scanning than the default, for a certain period of time. In step 742, the inquiry scanning device modifies device detection procedure decreasing the duration of an inquiry scanning interval. In step 744, if the inquiry scanning device determines that the predefined DIAC scan time has elapsed, then the method transitions to the idle state in step 732. Alternately, if the predefined DIAC scan time has not elapsed, then the method transitions to step 746 to continue scanning for special DIAC inquiry packets, looping back to step 738.

For some profiles, it may be beneficial for a, inquiry scanning device to start the special DIAC search only after receiving a GIAC inquiry packet. This is shown in FIG. 7C, where the receipt of a GIAC inquiry serves as an initiator for the special DIAC searching process. FIG. 7C is an example flow diagram of an example method, from the point of view of the inquiry scanning device first receiving a general inquiry (GIAC) packet before receiving a predetermined dedicated inquiry (DIAC) packet, in accordance with at least one embodiment of the present invention. The inquiry scanning device in this example, is a direction finding capable device, in accordance with embodiments of the invention. The example method is from the point of view of the inquiry scanning device perspective. In the idle state of step 762 the inquiry scanning device is discoverable. In steps 764 and 766, if the received inquiry packet is a GIAC inquiry (or a LIAC inquiry in some cases), then the inquiry scanning device responds in the normal fashion with an FHS packet and, optionally, a following extended inquiry response packet. The receipt of a GIAC inquiry in step 764 serves as an initiator for the special DIAC searching process by transitioning to step 776 to scan for special DIAC inquiry packets. The method loops to step 768. In step 768, when a special DIAC packet 150 is received, the inquiry scanning device responds by providing information usable for estimating at least a relative direction 164 and direction estimating data 169 and in step 770 transmitting that information in an extended inquiry response packet 160. When the inquiry scanning device receives the first special DIAC, a response packet is sent and the scanning interval for scanning special DIACs may be changed to a more frequent or continuous scanning than the default, for a certain period of time. In step 772, the inquiry scanning device modifies device detection procedure decreasing the duration of an inquiry scanning interval. In step 774, if the inquiry scanning device determines that the predefined DIAC scan time has elapsed, then the method transitions to the idle state in step 762. Alternately, if the predefined DIAC scan time has not elapsed, then the method transitions to step 776 to continue scanning for special DIAC inquiry packets, looping back to step 768.

### F. FORMATTING EXAMPLES FOR EXTENDED INQUIRY RESPONSE PACKET

FIG. 8 is an example of the standard format for the Bluetooth™ Extended Inquiry Response packet 160, as described in the Bluetooth™ Core Specification, Version 4.0. The payload data 161 is 240 octets and has two parts, a significant part followed by a non-significant part. The significant part contains a sequence of data structures 162. The non-significant part contains all zero octets. Each data structure 162 will have a length field of one octet, which contains the Length value, and a data field of Length octets. The first n octets of the data field 162 contain the extended inquiry response (EIR) data type 166. The content of the remaining EIR Data 164 of has a Length - n octets in the data field and depends on the value of the EIR data type and is called the EIR data. The non-significant part extends the extended inquiry response to 240 octets and will contain all-zero octets. EIR data types 166 may include Service Class Universally Unique Identifier (UUID), Local Name, flag bits, Manufacturer Specific Data, Transmission Power Level, and Secure Simple Pairing Out of Band (OOB). In embodiments of the invention, the EIR data types are expanded to include the Direction Type EIR Data with information usable for estimating at least a relative direction 164.

In embodiments of the invention, there are several options enumerated below, to include information enabling direction finding during the standard extended inquiry response process. The direction finding data may be added as a tail of the extended inquiry response packet or within the extended inquiry response packet. The data format of the basic extended inquiry response packet (000 . . . 000 field is not transmitted over the air) is shown in FIG. 7. The general packet structure in the FIG. 7 is somewhat simplified, not showing for example the payload header and the cyclic redundancy code (CRC) in the payload.

1. Option 1:

FIG. 8A is an example embodiment of a Bluetooth™ extended inquiry response packet 160 in a backwards compatible format, with the addition of a tail, according to at least one example embodiment. The payload portion 161′ includes data structures 162 that include the direction type 166 as the EIR data type, and the portion of the information usable for estimating at least a relative direction 164 that includes the direction estimation type 165 as either AoA, AoD, or both, the pattern 168, and the data and length 167, including, for example, coding, length of the direction estimation data, and properties of the antennas A, B, C, and D. In option 1, the extended inquiry response packet 160 includes a tail portion that contains the direction estimation data 169. The example embodiment adds support for direction estimation by defining a new extended inquiry response data type 166 with associated parameters and adding the direction estimation data 169 as a “tail” of the EIR packet 160. The direction estimation data 169 is appended to the end of the standard extended inquiry response packet 160, as shown in FIG. 8A. This option gives more flexibility for forming the direction estimation data 169, when compared to the following option 2 that incorporates the direction estimation data 169 within the body of the extended inquiry response packet 160, where it would have to be modulated in a manner similar to the rest of the packet 160 in order to support legacy devices. Also, an implementation of the receiver with option 2 may be more difficult due, for example, to signal strength variations from antenna to antenna, which may interfere with the operation of automatic gain control (AGC). The payload field 161′ of the packet 160 may include a data and length field 167, that includes data such as coding, length of the direction estimation data, properties of the antennas A, B, C, and D, a reference binary bit pattern 168, such as “11110000”, and other factors useful in enabling the inquiring device 102 to estimate a direction.

FIG. 8B is an example embodiment of Bluetooth™ extended inquiry response data 162′ in the payload field 161′ of option 1 in FIG. 8A in a backwards compatible format, where the tail portion that follows the payload field 161′ contains the direction estimation data 169, according to at least one embodiment. FIG. 8B the extended inquiry response data structure 162 in the payload field 161′, includes the “Direction Type” indication 166 that may be used to inform the receiving device about the existence and properties of the direction finding data and the direction estimation type 165 as either AoA, AoD, or both. The extended inquiry response data structure 162 in the payload field 161′, may also include the data and length field 167, that includes data such as coding, length of the direction estimation data, properties of the antennas A, B, C, and D, a reference binary bit pattern 168, such as “11110000”, and other factors useful in enabling the inquiring device 102 to estimate a direction.

FIG. 8C is an example list of the fields in the payload portion 161′ of the extended inquiry response packet 160 for option 1 in FIGS. 8A and 8B, in a backwards compatible format, according to at least one embodiment. The example list of the fields in the payload portion 161′, include the “Direction Type” indication 166 (“Direction signal as tail data”) that may be used to inform the receiving device about the existence and properties of the direction finding data. The example list of the fields may also include the direction estimation type 165 as either AoA, AoD, or both. The example list of the fields may also include the data and length field 167, that includes data such as coding, length of the direction estimation data, properties of the antennas A, B, C, and D, a reference binary bit pattern 168, such as “11110000”, and other factors useful in enabling the inquiring device 102 to estimate a direction.

2. Option 2:

FIG. 9 is an example embodiment of the direction estimation data 169 included within the payload portion 161 of the extended inquiry response packet 160, in a backwards compatible format, according to at least one embodiment. In this case the procedure is similar to Option 1, but instead of having a direction estimation data 169 “tail” following the payload portion 161 of the packet 160, the direction estimation data 169 is added into the payload portion 161. Since the direction estimation data 169 is binary data, such as ‘1111000011110000’ etc. that is contained within the payload portion 161 in option 2, data whitening should be turned off or otherwise compensated for during the transmission of the reference data stream 200.

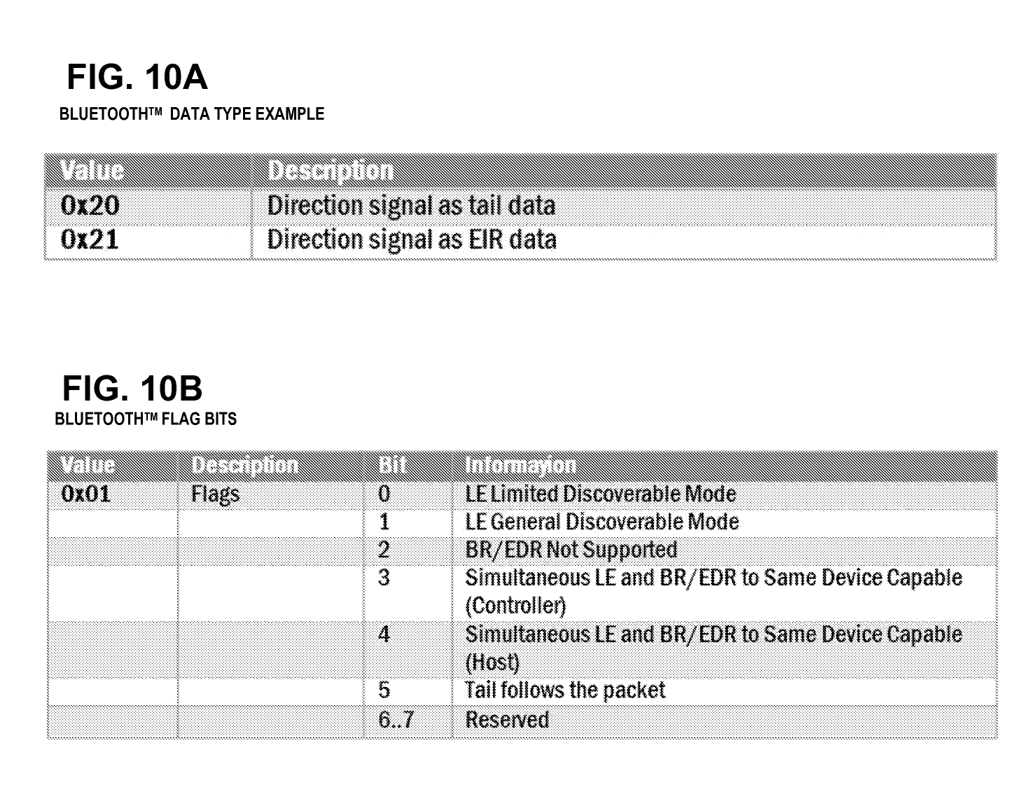

FIG. 10A is an example description of new values that may be used in the EIR Data Type field 166 to designate two example directional types in a backwards compatible format: “Direction signal as tail data” corresponding to option 1 and “Direction signal as EIR data” corresponding to option 2, to define the new extended inquiry response Data Type, according to at least one embodiment.

3. Option 3:

If the tail length and pattern is specified or otherwise known apriori, it may be indicated by the Flags in the EIR packet 160 for the type of extended inquiry response data. In this case, currently reserved bit(s) in the extended inquiry response packet 160 may be used to inform the receiving device that the direction estimation data 169 tail follows the standard extended inquiry response packet 160. In FIG. 10B, the reserved bit 5 of the extended inquiry response packet 160 is used to indicate that the direction estimation data 169 will be in the tail that will be following the packet 160 in a backwards compatible format. Note that 0x01 in the figure is extended inquiry response data type and bits are extended inquiry response data.

4. Option 4:

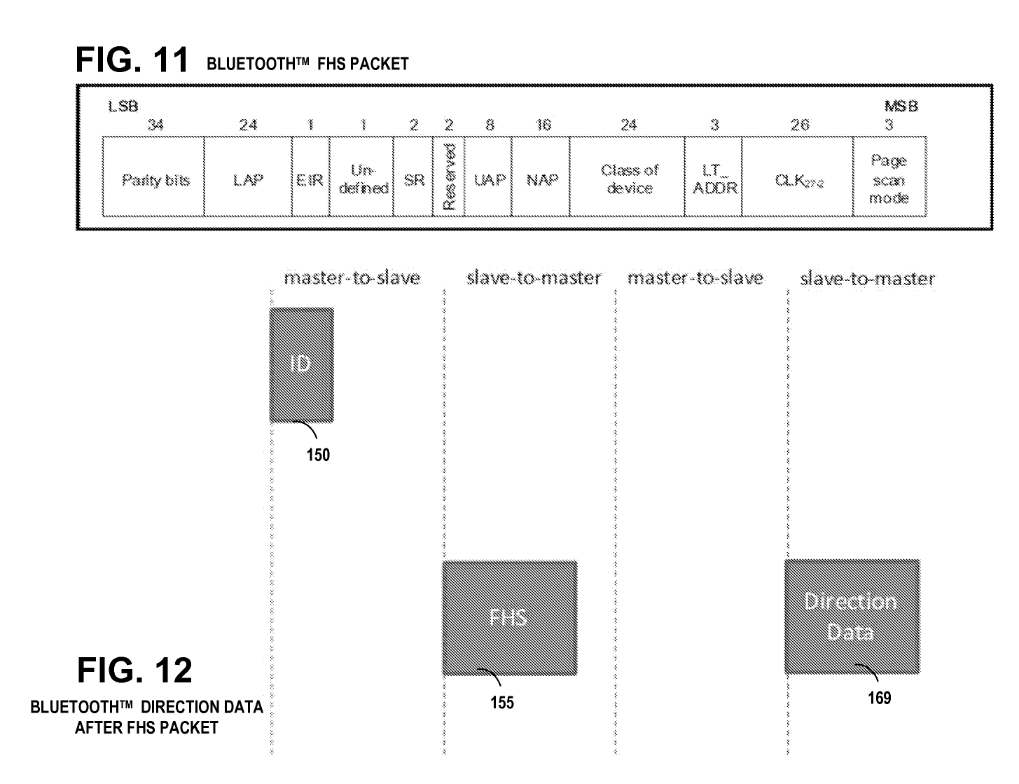

Option 4 is similar in functionality to Option 3, where the Flag bit(s) are used to indicate a following direction estimation data 169 tail, and the tail length and pattern is specified or otherwise known apriori. The difference in Option 4 is that the direction estimation data 169 tail is already indicated in the FHS packet 155 preceding the extended inquiry response packet 160, by using ‘Undefined’ bit in the FHS packet. This allows indicating that a dedicated direction estimation packet 169 follows, either immediately after the FHS packet, in FIG. 12, if the extended inquiry response packet is not present, or after the extended inquiry response packet, in FIG. 13, if the extended inquiry response packet follows the FHS packet. The FHS packet format shown in FIG. 11, includes the Bluetooth™ device address and the clock of the sender and the ‘Undefined’ bit is used in this example embodiment, to indicate the presence of the following packet containing the direction estimation data 169, shown in FIGS. 12 and 13.

### G. EXAMPLES OF MODIFYING THE INQUIRY SCANNING PROCEDURES

FIG. 14A is an example timing diagram during the inquiry scan state of an inquiry scanning device, after a general inquiry (GIAC) procedure, as described in described the Bluetooth™ Specification, Version 4, Jun. 30, 2010. The figure shows a diagram of transmitted inquiries by the inquiring device in the role of a potential master device in a potential piconet, the diagram of inquiries shown superimposed on a diagram of the inquiry scan intervals of the scanning device in the role of a potential slave in the potential piconet. The default inquiry scan intervals are 2.56 seconds and the default scan window is 11.25 milliseconds.

FIG. 14B is an example timing diagram during the inquiry scan state of an inquiry scanning device, after receiving a predetermined dedicated inquiry (DIAC), showing a diagram of transmitted inquiries by the inquiring device, shown superimposed on a diagram of the inquiry scan intervals of the scanning device, wherein the scanning device modifies the Bluetooth™ inquiry scanning procedures for receiving inquiry signals, by increasing the duration of the scan window in response to the receipt of a predetermined dedicated inquiry (DIAC) packet, according to an embodiment of the present invention. The scanning device modifies the Bluetooth™ inquiry scanning procedures by increasing the duration of the scan window to be larger than the default value of 11.25 milliseconds in response to receiving a predetermined dedicated inquiry (DIAC). In embodiments of the invention, the scan window may be enlarged so as to be continuous. This enables accelerating the Bluetooth™ inquiry procedure.

FIG. 14C is an example timing diagram during the inquiry scan state of an inquiry scanning device, after receiving a predetermined dedicated inquiry (DIAC), showing a diagram of transmitted inquiries by the inquiring device, shown superimposed on a diagram of the inquiry scan intervals of the scanning device, wherein the scanning device modifies the Bluetooth™ inquiry scanning procedures for receiving inquiry signals, by decreasing the duration of the scan interval between scans in response to the receipt of a predetermined dedicated inquiry (DIAC) packet, according to an embodiment of the present invention. The scanning device modifies the Bluetooth™ inquiry scanning procedures by decreasing a duration of an inquiry scanning interval to be less than the default value of 2.56 seconds in response to receiving a predetermined dedicated inquiry (DIAC). This enables accelerating the Bluetooth™ inquiry procedure.

In an example embodiment of the invention, an apparatus comprises:

means for scanning, by an apparatus, for wireless signals, the wireless signals comprising one or more inquiry messages;

means for receiving one or more predetermined dedicated inquiry messages and in response, providing information usable for estimating at least a relative direction of the apparatus; and

means for transmitting one or more response messages including an information message containing the information usable for estimating at least a relative direction of the apparatus.

In an example embodiment of the invention, an apparatus comprises:

means for transmitting, by an apparatus, one or more wireless predetermined dedicated inquiry messages;

means for receiving, by the apparatus from a remote device, one or more wireless response messages including an information message containing information usable for estimating at least a relative direction of the remote device, the one or more response messages being received in response to the one or more predetermined dedicated inquiry messages;

means for determining that the one or more wireless response messages include information usable for estimating at least a relative direction of the remote device; and

means for generating positioning data in the apparatus based on the received information usable for estimating at least a relative direction of the remote device, for direction estimation.

The resulting Invention enables direction estimation of the received signal in a short-range communication system. Various example embodiments are described with respect to Bluetooth™ device discovery, thus providing an opportunity to show direction estimation to the user when pairing devices.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
scanning, by an apparatus, for wireless signals, the wireless signals comprising one or more inquiry messages;
receiving one or more predetermined dedicated inquiry messages and in response, providing information usable for estimating at least a relative direction of the apparatus; and
transmitting one or more response messages including an information message containing the information usable for estimating at least a relative direction of the apparatus.

2. The method of claim 1, wherein the one or more predetermined dedicated inquiry messages includes a special value reserved for a Bluetooth™ inquiry access code, which signifies that a device sending the one or more predetermined dedicated inquiry messages is capable of receiving and using information usable for estimating at least a relative direction of the apparatus, for direction estimation.

3. The method of claim 1, wherein the one or more predetermined dedicated inquiry messages includes a special value reserved for a Bluetooth™ inquiry access code, which initiates the response by the apparatus.

4. The method of claim 1, wherein the one or more response messages includes a Bluetooth™ extended inquiry response packet that includes a data type indication to inform a receiving device that direction estimation data associated with the information usable for estimating at least a relative direction of the apparatus exists in one of a tail portion of the Bluetooth™ extended inquiry response packet or a payload portion of the Bluetooth™ extended inquiry response packet.

5. The method of claim 1, wherein the one or more response messages includes a Bluetooth™ FHS packet with an indication to inform a receiving device that direction estimation data associated with the information usable for estimating at least a relative direction of the apparatus exists in a subsequent packet after the FHS packet.

6. The method of claim 1, wherein the one or more response messages includes a Bluetooth™ extended inquiry response packet that includes FHS data and a data type indication to inform a receiving device that direction estimation data associated with the information usable for estimating at least a relative direction of the apparatus exists in one of a tail portion of the Bluetooth™ extended inquiry response packet or a payload portion of the Bluetooth™ extended inquiry response packet.

7. The method of claim 1, wherein direction estimation data associated with the information usable for estimating at least a relative direction enables at least one of an angle of departure estimation and an angle of arrival estimation.

8. The method of claim 1, further comprising modifying device detection procedure associated with the one or more predetermined dedicated inquiry messages, in response to receiving the one or more predetermined dedicated inquiry messages, by at least one of increasing a duration of an inquiry scanning window and decreasing a duration of an inquiry scanning interval.

9. The method of claim 1, wherein if the one or more predetermined dedicated inquiry messages include a first special value, then direction estimation data associated with the information usable for estimating at least a relative direction enables an angle of departure estimation and if the one or more predetermined dedicated inquiry messages include a second special value different from the first special value, then direction estimation data associated with the information usable for estimating at least a relative direction enables an angle of arrival estimation.

10. A method, comprising:
transmitting, by an apparatus, one or more wireless predetermined dedicated inquiry messages;
receiving, by the apparatus from a remote device, one or more wireless response messages including an information message containing information usable for estimating at least a relative direction of the remote device, the one or more response messages being received in response to the one or more predetermined dedicated inquiry messages;
determining that the one or more wireless response messages include information usable for estimating at least a relative direction of the remote device; and
generating positioning data in the apparatus based on the received information usable for estimating at least a relative direction of the remote device, for direction estimation.

11. The method of claim 10, wherein the one or more wireless predetermined dedicated inquiry messages includes a special value reserved for a Bluetooth™ inquiry access code, which signifies that the apparatus is capable of receiving and using information usable for estimating at least a relative direction of the remote device, for direction estimation.

12. The method of claim 10, wherein the one or more wireless response messages includes a Bluetooth™ extended inquiry response packet that includes a data type indication to inform a receiving device that direction estimation data associated with the information usable for estimating at least a relative direction of the remote device exists in one of a tail portion of the Bluetooth™ extended inquiry response packet or a payload portion of the Bluetooth™ extended inquiry response packet.

13. The method of claim 10, wherein the one or more wireless response messages includes a Bluetooth™ FHS packet with an indication to inform a receiving device that direction estimation data associated with the information usable for estimating at least a relative direction of the remote device exists in a subsequent packet after the FHS packet.

14. The method of claim 10, wherein the one or more wireless response messages includes a Bluetooth™ extended inquiry response packet that includes FHS data and a data type indication to inform a receiving device that direction estimation data associated with the information usable for estimating at least a relative direction of the remote device exists in one of a tail portion of the Bluetooth™ extended inquiry response packet or a payload portion of the Bluetooth™ extended inquiry response packet.

15. The method of claim 10, wherein direction estimation data associated with the information usable for estimating at least a relative direction enables at least one of an angle of departure estimation and an angle of arrival estimation.

16. The method of claim 10, further comprising:
processing direction data associated with the information usable for estimating at least a relative direction of the remote device to enable the generating of the positioning data, for direction estimation.

17. An apparatus, comprising:
at least one processor;
at least one memory including computer program code;
the at least one memory and the computer program code configured to, with the at least one processor, cause the apparatus at least to:
scan for wireless signals, the wireless signals comprising one or more inquiry messages;
receive one or more predetermined dedicated inquiry messages and in response, provide information usable for estimating at least a relative direction of the apparatus; and
transmit one or more response messages including an information message containing the information usable for estimating at least a relative direction of the apparatus.

18. The apparatus of claim 17, wherein the one or more predetermined dedicated inquiry messages includes a special value reserved for a Bluetooth™ inquiry access code, which signifies that a device sending the one or more predetermined dedicated inquiry messages is capable of receiving and using information usable for estimating at least a relative direction of the apparatus, for direction estimation.

19. The apparatus of claim 17, wherein the one or more predetermined dedicated inquiry messages includes a special value reserved for a Bluetooth™ inquiry access code, which initiates the response by the apparatus.

20. The apparatus of claim 17, further comprising:
the at least one memory and the computer program code configured to, with the at least one processor, cause the apparatus at least to:
modify device detection procedure associated with the one or more predetermined dedicated inquiry messages, in response to receiving the one or more predetermined dedicated inquiry messages, by at least one of increasing a duration of an inquiry scanning window and decreasing a duration of an inquiry scanning interval.

21. An apparatus, comprising:
at least one processor;
at least one memory including computer program code;
the at least one memory and the computer program code configured to, with the at least one processor, cause the apparatus at least to:
transmit one or more wireless predetermined dedicated inquiry messages;
receive from a remote device, one or more wireless response messages including an information message containing information usable for estimating at least a relative direction of the remote device, the one or more response messages being received in response to the one or more predetermined dedicated inquiry messages;
determine that the one or more wireless response messages include information usable for estimating at least a relative direction of the remote device; and
generate positioning data in the apparatus based on the received information usable for estimating at least a relative direction of the remote device, for direction estimation.

22. The apparatus of claim 21, wherein the one or more wireless predetermined dedicated inquiry messages includes a special value reserved for a Bluetooth™ inquiry access code, which signifies that the apparatus is capable of receiving and using information usable for estimating at least a relative direction of the remote device, for direction estimation.

23. The apparatus of claim 21, wherein direction estimation data associated with the information usable for estimating at least a relative direction enables at least one of an angle of departure estimation and an angle of arrival estimation.

24. The apparatus of claim 21, further comprising:
the at least one memory and the computer program code configured to, with the at least one processor, cause the apparatus at least to:
process direction data associated with the information usable for estimating at least a relative direction of the remote device to enable the generating of the positioning data, for direction estimation.

25. A computer program product comprising computer executable program code recorded on a computer readable, non-transitory storage medium, the computer executable program code comprising:
code for scanning, by an apparatus, for wireless signals, the wireless signals comprising one or more inquiry messages;
code for receiving one or more predetermined dedicated inquiry messages and in response, providing information usable for estimating at least a relative direction of the apparatus; and
code for transmitting one or more response messages including an information message containing the information usable for estimating at least a relative direction of the apparatus.

26. A computer program product comprising computer executable program code recorded on a computer readable, non-transitory storage medium, the computer executable program code comprising:
code for transmitting, by an apparatus, one or more wireless predetermined dedicated inquiry messages;
code for receiving, by the apparatus from a remote device, one or more wireless response messages including an information message containing information usable for estimating at least a relative direction of the remote device, the one or more response messages being received in response to the one or more predetermined dedicated inquiry messages;
code for determining that the one or more wireless response messages include information usable for estimating at least a relative direction of the remote device; and
code for generating positioning data in the apparatus based on the received information usable for estimating at least a relative direction of the remote device, for direction estimation.
